(19) United States
(12) Patent Application Publication
(10) Pub. No.: US 2018/0261154 A1
(43) Pub. Date: Sep. 13, 2018

(54) METHOD FOR DRIVING DISPLAY ELEMENT, DISPLAY DEVICE, AND ELECTRONIC DEVICE

(71) Applicant: SONY CORPORATION, TOKYO (JP)

(72) Inventor: NAOBUMI TOYOMURA, KANAGAWA (JP)

(21) Appl. No.: 15/760,551

(22) PCT Filed: Jul. 19, 2016
(86) PCT No.: PCT/JP2016/071142

§ 371 Date: Mar. 15, 2018

(30) Foreign Application Priority Data
Sep. 30, 2015 (JP) 2015-193471

(51) Int. Cl. G09G 3/3233

(52) U.S. Cl. CPC G09G 3/3233; G09G 2300/0819; G09G 2320/045; G09G 2320/0233

(57) ABSTRACT

In driving a display element including an n-channel drive transistor in which a voltage is applied to one source/drain region and a light-emitting unit is connected to another source/drain region, and a capacitor connected between a gate electrode and the other source/drain region, processing is performed to: apply a drive voltage to the one source/drain region in a state where a reference voltage is applied to the gate electrode of the drive transistor, to bring a potential of the other source/drain region closer to a potential obtained by subtracting a threshold voltage of the drive transistor from the reference voltage; and subsequently, set the gate electrode in a floating state, and change a potential of the gate electrode in the floating state via parasitic capacitance and cause a current to flow via the drive transistor to increase a voltage between the other source/drain region and the gate electrode, and then apply the reference voltage to the gate electrode.

### TECHNICAL FIELD

The present disclosure relates to a method for driving a display element, a display device, and an electronic device.

### BACKGROUND ART

A display element including a current drive type light-emitting unit, and a display device including the display element are known. For example, a display element including a light-emitting unit utilizing electroluminescence of an organic material (hereinafter may be simply referred to as an organic EL display element) is noted as a display element capable of high luminance light emission by low voltage direct current drive.

Similarly to a liquid crystal display device, for example, in a display device including the organic EL display element, a simple matrix system and an active matrix system are known as a drive system. The active matrix system has a disadvantage that its structure is complicated, but has an advantage that a luminance of an image can be increased, for example. The organic EL display element driven by the active matrix system includes a light-emitting unit including an organic layer including a light emitting layer and the like, and also includes a drive circuit for driving the light-emitting unit.

As a circuit for driving the current drive type light-emitting unit, for example, a drive circuit including two transistors and one capacitor (referred to as a 2Tr/1C drive circuit) is known from, for example, Japanese Patent Application Laid-Open No. 2007-310311 (Patent Document 1). As illustrated in FIG. 1, the 2Tr/1C drive circuit includes two transistors, a write transistor TR_{W} and a drive transistor TR_{D}, and one capacitor C_{S}. Here, a gate electrode of the drive transistor TR_{D} configures a first node ND₁, and a source/drain region connected to a light-emitting unit ELP configures a second node ND₂.

The capacitor C_{S} is used to hold a voltage of the gate electrode (so-called gate-source voltage) with respect to a source region of the drive transistor TR_{D}. Here, a threshold voltage Vₜₕ of the drive transistor TR_{D} varies for each display element. Therefore, if the voltage held by the capacitor C_{S} is a voltage reflecting only a video signal voltage, luminance unevenness occurs due to variation in the threshold voltage Vₜₕ. For this reason, the drive circuit is driven such that the voltage held by the capacitor C_{S} is a voltage reflecting the video signal voltage and the threshold voltage Vₜₕ.

If the write transistor TR_{W} is set in a non-conductive state in a state where the voltage reflecting the video signal voltage and the threshold voltage Vₜₕ is held by the capacitor C_{S}, a current flows via the drive transistor, and the light-emitting unit ELP emits light. A voltage of an anode electrode of the light-emitting unit ELP, in other words, a voltage of the second node ND₂ increases with light emission of the light-emitting unit ELP. At this time, the voltage of the gate electrode of the drive transistor TR_{D}, in other words, the voltage of the first node ND₁, increases due to bootstrap operation. If ideal bootstrap operation occurs, the gate-source voltage is kept before and after the bootstrap operation, so that the luminance unevenness does not occur due to the variation in the threshold voltage Vₜₕ of the drive transistor.

### CITATION LIST

### Patent Document

### Patent Document 1: Japanese Patent Application Laid-Open No. 2007-310311

### SUMMARY OF THE INVENTION

### Problems to be Solved by the Invention

Actually, due to influence of parasitic capacitance of the drive transistor TR_{D} or the like, an amount of increase in the voltage of the first node ND₁ during the bootstrap operation is less than an amount of increase in the voltage of the second node ND₂. In addition, the amount of increase in the voltage of the second node ND₂ during the bootstrap operation changes in accordance with the threshold voltage Vₜₕ of the drive transistor TR_{D}. For this reason, a degree of a voltage change of the capacitor C_{S} before and after the bootstrap operation varies depending on a value of the threshold voltage Vₜₕ of the drive transistor TR_{D}. Qualitatively, as the threshold voltage Vₜₕ increases, the voltage of the capacitor C_{S} decreases due to the bootstrap operation, and as a result, the current flowing through the light-emitting unit ELP decreases. This causes the luminance unevenness.

Therefore, an object of the present disclosure is to provide a display device and a method for driving the display device capable of reducing the luminance unevenness due to the bootstrap operation.

### Solutions to Problems

A method for driving a display element of the present disclosure to achieve the object described above, includes:

in driving a display element including an n-channel drive transistor in which a voltage is applied to one source/drain region and a light-emitting unit is connected to another source/drain region, and a capacitor connected between a gate electrode of the drive transistor and the other source/drain region,

performing threshold voltage cancellation processing that applies a drive voltage to the one source/drain region in a state where a reference voltage is applied to the gate electrode of the drive transistor, to bring a potential of the other source/drain region closer to a potential obtained by subtracting a threshold voltage of the drive transistor from the reference voltage;

subsequently, setting the gate electrode of the drive transistor in a floating state, and changing a potential of the gate electrode in the floating state via parasitic capacitance and causing a current to flow via the drive transistor to increase a voltage between the other source/drain region and the gate electrode, and then applying the reference voltage to the gate electrode of the drive transistor;

afterwards, performing write processing that applies a video signal voltage to the gate electrode of the drive transistor; and

subsequently, setting the gate electrode of the drive transistor in the floating state to cause the light-emitting unit to emit light.

A display device of the present disclosure to achieve the object described above, includes:

a display unit in which a display element is disposed, the display element including an n-channel drive transistor in which a voltage is applied to one source/drain region and a light-emitting unit is connected to another source/drain region, and a capacitor connected between a gate electrode of the drive transistor and the other source/drain region; and a drive unit that drives the display unit, in which

the drive unit

performs threshold voltage cancellation processing that applies a drive voltage to the one source/drain region in a state where a reference voltage is applied to the gate electrode of the drive transistor, to bring a potential of the other source/drain region closer to a potential obtained by subtracting a threshold voltage of the drive transistor from the reference voltage,

subsequently, sets the gate electrode of the drive transistor in a floating state, and changes a potential of the gate electrode in the floating state via parasitic capacitance and causing a current to flow via the drive transistor to increase a voltage between the other source/drain region and the gate electrode, and then applies the reference voltage to the gate electrode of the drive transistor,

afterwards, performs write processing that applies a video signal voltage to the gate electrode of the drive transistor, and

subsequently, sets the gate electrode of the drive transistor in the floating state to cause the light-emitting unit to emit light.

An electronic device of the present disclosure to achieve the object described above is

an electronic device including a display device, in which

the display device includes:

a display unit in which a display element is disposed, the display element including an n-channel drive transistor in which a voltage is applied to one source/drain region and a light-emitting unit is connected to another source/drain region, and a capacitor connected between a gate electrode of the drive transistor and the other source/drain region; and a drive unit that drives the display unit, in which

the drive unit

performs threshold voltage cancellation processing that applies a drive voltage to the one source/drain region in a state where a reference voltage is applied to the gate electrode of the drive transistor, to bring a potential of the other source/drain region closer to a potential obtained by subtracting a threshold voltage of the drive transistor from the reference voltage,

subsequently, sets the gate electrode of the drive transistor in a floating state, and changes a potential of the gate electrode in the floating state via parasitic capacitance and causing a current to flow via the drive transistor to increase a voltage between the other source/drain region and the gate electrode, and then applies the reference voltage to the gate electrode of the drive transistor,

afterwards, performs write processing that applies a video signal voltage to the gate electrode of the drive transistor, and

subsequently, sets the gate electrode of the drive transistor in the floating state to cause the light-emitting unit to emit light.

### Effects of the Invention

With the method for driving a display device according to the present disclosure, after the threshold voltage cancellation processing is performed, the gate electrode of the drive transistor is set in the floating state, and the potential of the gate electrode in the floating state is changed via the parasitic capacitance and the current is caused to flow via the drive transistor to increase the voltage between the other source/drain region and the gate electrode, and then the reference voltage is applied to the gate electrode of the drive transistor. A voltage change of the other source/drain region of the drive transistor due to this operation reduces a phenomenon that the voltage of the capacitor C_{S} decreases due to the bootstrap operation as the threshold voltage Vₜₕ increases. As a result, the luminance unevenness due to the bootstrap operation can be reduced. In the display device and the electronic device of the present disclosure, an image can be displayed with reduced luminance unevenness due to the bootstrap operation.

### BRIEF DESCRIPTION OF DRAWINGS

FIG. 1 is a conceptual diagram of a display device according to a first embodiment.

FIG. 2 is a schematic partial cross-sectional view of a portion including a display element in a display unit.

FIG. 3 is a schematic timing chart for explaining operation of the display device according to the first embodiment, more specifically, operation of an (n, m)-th display element of the display device.

FIG. 4 is a schematic timing chart for explaining operation of a display device of a reference example in which a first drive voltage V_{CC-M} applied to a feeder line in a [period-TP₂] and a [period-TP₃] of FIG. 3 is set to a drive voltage V_{CC-H} and a pulse applied to a scanning line in the [period-TP₃] is omitted.

FIGS. 5A and 5B are diagrams each schematically illustrating a conductive state/non-conductive state and the like of each transistor configuring a drive circuit of a display element according to the display device of the reference example.

FIGS. 6A and 6B are diagrams each schematically illustrating the conductive state/non-conductive state and the like of each transistor configuring the drive circuit of the display element according to the display device of the reference example, continuing from FIG. 5B.

FIGS. 7A and 7B are diagrams each schematically illustrating the conductive state/non-conductive state and the like of each transistor configuring the drive circuit of the display element according to the display device of the reference example, continuing from FIG. 6B.

FIGS. 8A and 8B are diagrams each schematically illustrating the conductive state/non-conductive state and the like of each transistor configuring the drive circuit of the display element according to the display device of the reference example, continuing from FIG. 7B.

FIG. 9 is a diagram for explaining a bootstrap gain G_{bst} indicating a ratio of a gate voltage change to a source voltage change of a drive transistor in bootstrap operation in a [period-TP₄] to a [period-TP₅] illustrated in FIG. 4.

FIG. 10 is a schematic timing chart for explaining the operation when the bootstrap gain G_{bst} is “1”.

FIG. 11 is a schematic timing chart for explaining the operation when the bootstrap gain G_{bst} is “0.6”.

FIGS. 12A and 12B are diagrams each explaining a value of a gate-source voltage V_{gs} of the drive transistor in the [period-TP₄] and the [period-TP₅] illustrated in FIG. 4, and FIG. 12A illustrates a case where a threshold voltage of the transistor is Vₜₕ₁, and FIG. 12B illustrates a case where the threshold voltage of the drive transistor is Vₜₕ₂ (>Vₜₕ₁).

FIGS. 13A and 13B are diagrams each schematically illustrating a conductive state/non-conductive state and the like of each transistor configuring a drive circuit of a display element according to the display device of the first embodiment.

FIGS. 14A and 14B are diagrams each schematically illustrating the conductive state/non-conductive state and the like of each transistor configuring the drive circuit of the display element according to the display device of the first embodiment, continuing from FIG. 13B.

FIGS. 15A and 15B are diagrams each schematically illustrating the conductive state/non-conductive state and the like of each transistor configuring the drive circuit of the display element according to the display device of the first embodiment, continuing from FIG. 14B.

FIG. 16 is a schematic timing chart for explaining changes in the gate voltage and the source voltage of the drive transistor, in the display element including the drive transistor whose threshold voltage is Vₜₕ₁ and the display element including the drive transistor whose threshold voltage is Vₜₕ₂ (>Vₜₕ₁), in the display device according to the first embodiment.

FIG. 17 is a table for explaining the voltage changes in FIG. 16.

FIG. 18 is a conceptual diagram of a display device according to a modification of the first embodiment.

FIG. 19 is a conceptual diagram of a display device according to a second embodiment.

FIG. 20 is a schematic timing chart for explaining operation of the display device according to the second embodiment, more specifically, operation of an (n, m)-th display element of the display device.

FIGS. 21A and 21B are diagrams each schematically illustrating a conductive state/non-conductive state and the like of each transistor configuring a drive circuit of a display element according to the display device of the second embodiment.

FIGS. 22A and 22B are diagrams each schematically illustrating the conductive state/non-conductive state and the like of each transistor configuring the drive circuit of the display element according to the display device of the second embodiment, continuing from FIG. 21B.

FIGS. 23A and 23B are diagrams each schematically illustrating the conductive state/non-conductive state and the like of each transistor configuring the drive circuit of the display element according to the display device of the second embodiment, continuing from FIG. 22B.

FIGS. 24A and 24B are diagrams each schematically illustrating the conductive state/non-conductive state and the like of each transistor configuring the drive circuit of the display element according to the display device of the second embodiment, continuing from FIG. 23B.

FIGS. 25A and 25B are diagrams each schematically illustrating the conductive state/non-conductive state and the like of each transistor configuring the drive circuit of the display element according to the display device of the second embodiment, continuing from FIG. 24B.

FIG. 26 is a diagram schematically illustrating the conductive state/non-conductive state and the like of each transistor configuring the drive circuit of the display element according to the display device of the second embodiment, continuing from FIG. 25B.

FIG. 27 is a conceptual diagram of a display device according to a modification of the second embodiment.

FIG. 28 is a conceptual diagram of a display device according to a modification of the second embodiment.

FIG. 29 is an external view of a lens interchangeable single lens reflex type digital still camera, and FIG. 29A illustrates a front view of the camera and FIG. 29B illustrates a rear view of the camera.

FIG. 30 is an external view of a head mounted display.

FIG. 31 is an external view of a see-through head mounted display.

### MODE FOR CARRYING OUT THE INVENTION

Hereinafter, the present disclosure will be described on the basis of embodiments with reference to the drawings. The present disclosure is not limited to the embodiments, and various numerical values and materials in the embodiments are examples. In the following description, the same reference signs will be used for the same elements or elements having the same function, and redundant description will be omitted. Note that, description will be made in the following order.

1. General Description related to Method for Driving Display Element, Display Device, and Electronic Device according to Present Disclosure

2. First Embodiment

3. Second Embodiment

4. Description of Electronic Device and Others

General Description related to Method for Driving Display Element, Display Device, and Electronic Device according to Present Disclosure

A method for driving a display element, a display device, and an electronic device according to the present disclosure (hereinafter may be simply referred to as “the present disclosure”), each can have a configuration in which

threshold voltage cancellation processing is performed to apply a first drive voltage to one source/drain region in a state where a reference voltage is applied to a gate electrode of a drive transistor, to bring a potential of another source/drain region closer to a potential obtained by subtracting a threshold voltage of the drive transistor from the reference voltage, and

subsequently, the gate electrode of the drive transistor is set in a floating state and a voltage of the one source/drain region of the drive transistor is switched to a second drive voltage exceeding the first drive voltage, to change a potential of the gate electrode in the floating state via parasitic capacitance and cause a current to flow via the drive transistor, to increase a voltage between the other source/drain region and the gate electrode, and then the reference voltage is applied to the gate electrode of the drive transistor.

The present disclosure including a preferable configuration described above can have a configuration in which before the threshold voltage cancellation processing, the potential of the other source/drain region is initialized by switching the voltage applied to the one source/drain region of the drive transistor from the second drive voltage to an initialization voltage. In this case, the initialization voltage can be a voltage set to a predetermined value lower than a voltage obtained by subtracting the threshold voltage of the drive transistor from the reference voltage.

The present disclosure including various preferable configurations described above can have a configuration in which the display element further includes a write transistor connected to the gate electrode of the drive transistor, and the video signal voltage is applied to the gate electrode of the drive transistor via the write transistor set in a conductive state. In this case, the present disclosure can have a configuration in which the reference voltage is applied to the gate electrode of the drive transistor via the write transistor set in the conductive state.

Alternatively, the present disclosure can have a configuration in which

a voltage is applied to the one source/drain region of the drive transistor via a light emission control transistor,

the threshold voltage cancellation processing is performed to apply the drive voltage to the one source/drain region of the drive transistor via the light emission control transistor set in a conductive state due to application of a first control voltage to its gate electrode, in a state where the reference voltage is applied to the gate electrode of the drive transistor, to bring the potential of the other source/drain region closer to the potential obtained by subtracting the threshold voltage of the drive transistor from the reference voltage, and

subsequently, the gate electrode of the drive transistor is set in the floating state and the voltage applied to the gate of the light emission control transistor is switched to a second control voltage exceeding the first control voltage, to change the potential of the gate electrode in the floating state via the parasitic capacitance and cause the current to flow via the drive transistor, to increase the voltage between the other source/drain region and the gate electrode, and then the reference voltage is applied to the gate electrode of the drive transistor.

Also in this case, the present disclosure can have a configuration in which the display element further includes a write transistor connected to the gate electrode of the drive transistor, and the video signal voltage is applied to the gate electrode of the drive transistor via the write transistor set in a conductive state. Then, the present disclosure can have a configuration in which before the threshold voltage cancellation processing, the light emission control transistor is set in the non-conductive state and a voltage exceeding the reference voltage is applied to the gate electrode of the drive transistor and subsequently the reference voltage is applied, to initialize the potential of the other source/drain region of the drive transistor. In this case, the present disclosure can have a configuration in which the voltage exceeding the reference voltage and the reference voltage are applied to the gate electrode of the drive transistor via the write transistor set in the conductive state.

The present disclosure including the various preferable configurations described above can have a configuration in which the potential of the other source/drain region of the drive transistor changes due to the current flowing through the drive transistor, in the write processing.

The present disclosure including various preferable configurations described above can have a configuration in which the light-emitting unit includes a current drive type electro-optical element whose light emission luminance varies in accordance with a value of a current flowing. Examples of the current drive type light-emitting unit include an organic electroluminescence light-emitting unit, an LED light-emitting unit, and a semiconductor laser light-emitting unit. These light-emitting units can be configured using known materials and methods. From a viewpoint of configuring a flat type display device, the light-emitting unit preferably includes the organic electroluminescence light-emitting unit among the current drive type light-emitting units.

The drive unit used in the present disclosure including various preferable configurations described above includes circuits such as a scanning unit, a data driver, and a power supply unit. These circuits can be configured using known circuit elements and the like.

The display device may have a so-called monochrome display configuration or a color display configuration. The color display configuration can have a configuration in which one pixel includes a plurality of sub-pixels, more specifically, one pixel includes three sub-pixels, a red light emitting sub-pixel, a green light emitting sub-pixel, and a blue light emitting sub-pixel. Further, the color display configuration can be configured from one set to which one or more kinds of sub-pixels are further added to these three kinds of sub-pixels (for example, one set to which a sub-pixel emitting white light is added for improving luminance, one set to which sub-pixels respectively emitting complementary colors are added for expanding a color reproduction range, one set to which a sub-pixel emitting yellow is added for expanding the color reproduction range, and one set to which sub-pixels respectively emitting yellow and cyan are added for expanding the color reproduction ranges).

As pixel values of the display device, some of the image display resolutions can be exemplified, such as VGA (640, 480), S-VGA (800, 600), XGA (1024, 768), APRC (1152, 900), S-XGA (1280, 1024), U-XGA (1600, 1200), HD-TV (1920,1080), and Q-XGA (2048,1536), and in addition, (1920, 1035), (720, 480), and (1280, 960); however, the pixel values are not limited to these values.

The display element configuring the display unit is formed in a certain plane (for example, formed on a support), and the light-emitting unit is formed above a drive circuit that drives the light-emitting unit, via an interlayer insulating layer, for example.

The drive circuit that drives the light-emitting unit can be configured as a circuit including a transistor and a capacitor. Examples of the transistor configuring the drive circuit include a thin film transistor (TFT). The transistor may be of an enhancement type or a depletion type. In an n-channel transistor, a lightly doped drain structure (LDD structure) may be formed. In some cases, the LDD structure may be formed asymmetrically. For example, since a large current flows through the drive transistor during light emission of the display element, it is also possible to adopt a configuration in which the LDD structure is formed only in the one source/drain region to be the drain region during the light emission. A configuration of the drive circuit is not particularly limited as far as the drive circuit is suitable for operation of the present disclosure.

In two source/drain regions included in one transistor, the term “one source/drain region” may be used in the meaning of a source/drain region connected to a power supply side. In addition, “a transistor is in a conductive state” means a state in which a channel is formed between the source/drain regions. It does not matter whether or not a current flows from the one source/drain region to the other source/drain region of the transistor. On the other hand, “a transistor is in a non-conductive state” means a state in which no channel is formed between the source/drain regions. In addition, the source/drain regions not only can be configured from a conductive material such as polysilicon or amorphous silicon containing impurities, but also can be configured from a metal, an alloy, conductive particles, a laminated structure thereof, or a layer including an organic material (conductive polymer).

The capacitor configuring the drive circuit can be configured from one electrode, the other electrode, and a dielectric layer sandwiched between these electrodes. The above-described transistor and the capacitor configuring the drive circuit are formed in a certain plane (for example, formed on the support), and the light-emitting unit is formed above the transistor and the capacitor configuring the drive circuit, via an interlayer insulating layer, for example. In addition, the other source/drain region of the drive transistor is connected to one end of the light-emitting unit (an anode electrode and the like included in the light-emitting unit) via a contact hole, for example. Note that, a configuration may be adopted in which a transistor is formed on a semiconductor substrate or the like.

Various wiring lines such as scanning lines, data lines, and feeder lines are formed on a certain plane (for example, on the support). These wiring lines can have known configurations and structures.

As a constituent material of the support or a substrate as described later, glass materials can be exemplified, such as high-strain point glass, soda glass (Na₂O.CaO.SiO₂), borosilicate glass (Na₂O.B₂O₃.SiO₂), forsterite (2MgO.SiO₂), and lead glass (Na₂O.PbO.SiO₂), and in addition, polymeric materials having flexibility can be exemplified, such as polyether sulfone (PES), polyimide, polycarbonate (PC), and polyethylene terephthalate (PET). Note that, various coatings may be applied to surfaces of the support and the substrate. The constituent materials of the support and the substrate may be the same as each other or different from each other. If the support and substrate including the polymeric material having flexibility are used, a display device having flexibility can be configured.

Conditions shown in various expressions in the present specification are satisfied not only in a case where each of the expressions mathematically strictly holds but also in a case where each of the expressions substantially holds. With respect to holding of the expressions, existence is permitted of various variations caused by designing or manufacturing the display element and the display device.

In the timing chart used in the following description, the length (time length) of the horizontal axis indicating each period is a schematic one and does not indicate the ratio of the time length of each period. This also applies to the vertical axis. The shape of the waveform in the timing chart is also schematic.

### FIRST EMBODIMENT

A first embodiment relates to a display element and a method for driving the display element, and a display device and a method for driving the display device according to the present disclosure.

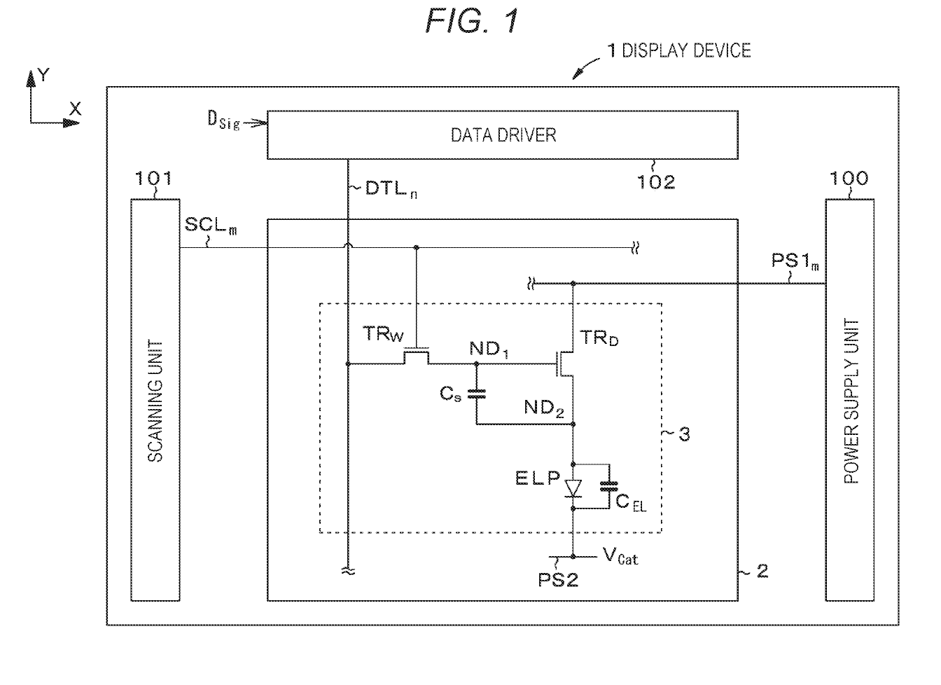

FIG. 1 is a conceptual diagram of the display device according to the first embodiment. A display device 1 includes a display unit 2. The display unit 2 includes display elements 3 each including a light-emitting unit and a drive circuit that drives the light-emitting unit. The display elements 3 are arranged in a two-dimensional matrix in a state of being connected to a scanning line SCL extending in a row direction (X direction in FIG. 1) and a data line DTL extending in a column direction (Y direction in FIG. 1). Note that, for convenience of illustration, FIG. 1 illustrates a connection relationship for one display element 3, more specifically, an (n, m)-th display element 3 as described later.

The display device 1 further includes a power supply unit 100, a scanning unit 101, and a data driver 102. A drive unit for driving the display unit 2 includes these units.

A scanning signal is supplied to the scanning line SCL from the scanning unit 101. A video signal voltage according to a luminance of an image to be displayed and the like are supplied to the data line DTL. A drive voltage and the like are supplied from the power supply unit 100 to a feeder line PS1. Note that, a common voltage (for example, a ground potential) is supplied to a common feeder line PS2 as described later.

Although not illustrated in FIG. 1, an area (display area) in which the display panel 2 displays an image includes the display elements 3 arranged in a two-dimensional matrix of N elements in the row direction and M elements in the column direction, total N×M elements. The number of rows of the display elements 3 in the display area is M, and the number of the display elements 3 configuring rows is N.

The number of the scanning lines SCL and the number of the feeder lines PS1 are each M. The display elements 3 in an m-th row (where m=1, 2, . . . , M) are connected to an m-th scanning line SCLₘ and an m-th feeder line PS1ₘ, and configure one display element row. Note that, in FIG. 1, only the scanning line SCLₘ and the feeder line PS1ₘ are illustrated.

In addition, the number of the data lines DTL is N. The display elements 3 in an n-th column (where n=1, 2, . . . , N) are connected to an n-th data line DTLₙ. Note that, in FIG. 1, only the data line DTLₙ is illustrated.

The display element 3 includes an n-channel drive transistor TR_{D} in which a voltage is applied to one source/drain region and a light-emitting unit ELP is connected to the other source/drain region, and a capacitor C_{S} connected between a gate electrode of the drive transistor TR_{D} and the other source/drain region, and further includes a write transistor TR_{W} connected to the gate electrode of the drive transistor TR_{D}. The drive transistor TR_{D} and the write transistor TR_{W} each include an re-channel TFT. Note that, for example, the write transistor TR_{W} can include a p-channel TFT. In addition, the display element 3 may further include another transistor.

One source/drain region of the write transistor TR_{W} is connected to the data line DTL, and its gate electrode is connected to the scanning line SCL.

The gate electrode of the drive transistor TR_{D} is connected to the other source/drain region of the write transistor TR_{W}, and is connected to one electrode of the capacitor C_{S}, to configure a first node ND₁. One source/drain region of the drive transistor TR_{D} is connected to the feeder line PS1, and the other source/drain region is connected to one end of the light-emitting unit ELP (more specifically, an anode electrode included in the light-emitting unit ELP) and is connected to the other electrode of the capacitor C_{S}, to configure a second node ND₂.

The capacitor C_{S} is used to hold a voltage of the gate electrode (so-called gate-source voltage) with respect to a source region of the drive transistor TR_{D}. The “source region” in this case means a source/drain region on a side serving as a “source region” when the light-emitting unit ELP emits light. In a light emitting state of the display element 3, the one source/drain region (the side connected to the feeder line PS1 in FIG. 1) of the drive transistor TR_{D} serves as a drain region, and the other source/drain region (one end of the light-emitting unit ELP, specifically, the side connected to the anode electrode) serves as a source region.

The display device 1 is a monochrome display device, for example, and one display element 3 configures one pixel. In accordance with the scanning signal from the scanning unit 101, line-sequential scanning is performed on the display device 1 for each row. The display element 3 located in the m-th row and the n-th column is hereinafter referred to as the (n, m)-th display element 3 or the (n, m)-th pixel. In addition, a scanning period (horizontal scanning period) assigned to the display element in the m-th row is represented by a reference sign Hₘ.

In the display device 1, the display elements 3 configuring N pixels arranged in the m-th row are simultaneously driven. In other words, in N display elements 3 arranged along the row direction, timing of light emission/non-light emission is controlled for each row to which the N display elements 3 belong. If a display frame rate of the display device 1 is represented as FR (times/second), the scanning period per row (so-called horizontal scanning period) when the line sequential scanning is performed on the display device 1 for each row is less than (1/FR)×(1/M) seconds.

A video signal D_{Sig} representing a gradation according to an image to be displayed is input to the display device 1 from a device not illustrated, for example. The video signal D_{Sig} is a digital signal having a gradation bit length such as 8 bits, 16 bits, and 24 bits. A video signal corresponding to the (n, m)-th display element 3 among the image signal D_{Sig} input may be represented as D_{Sig(n, m)}.

The data driver 102 generates a voltage corresponding to a value of the video signal D_{Sig} and supplies the voltage to the data line DTL. The video signal voltage corresponding to the video signal D_{Sig} is represented as V_{Sig}. In addition, in a case of indicating that the video signal voltage V_{Sig} corresponds to the (n, m)-th display element 3, for example, the video signal voltage may be represented as a video signal voltage V_{Sig(n, m)} or a video signal voltage V_{Sig}_{_}ₘ.

Note that, in the first embodiment, the data driver 102 alternately supplies a reference voltage V_{Ofs} and the video signal voltage V_{Sig} to the data line DTL. Specifically, the reference voltage V_{Ofs} is supplied in the first half of the horizontal scanning period and the video signal voltage V_{Sig} is supplied in the latter half.

The power supply unit 100 supplies a first drive voltage V_{CC-M}, a second drive voltage V_{CC-H}, and an initialization voltage V_{CC-L} to the feeder line PS1.

The scanning unit 101 supplies the scanning signal to the scanning line SCL. As a result, a conductive state/non-conductive state is controlled of the write transistor TR_{W} connected to the scanning line SCL.

The light-emitting unit ELP is a current drive type electro-optical element whose light emission luminance varies in accordance with a value of a current flowing, and specifically, includes an organic electroluminescence element. The light-emitting unit ELP has known configuration and structure including an anode electrode, a hole transporting layer, a light emitting layer, an electron transporting layer, a cathode electrode, and the like.

A voltage V_{Cat} (for example, 0 [volts]) is applied to the other end (specifically, the cathode electrode) of the light-emitting unit ELP from the common feeder line PS2. Capacitance of the light-emitting unit ELP is represented by a reference sign C_{EL}. In addition, a threshold voltage required for light emission of the light-emitting unit ELP is V_{th-EL}. If a voltage equal to or higher than V_{th-EL} is applied between the anode electrode and the cathode electrode of the light-emitting unit ELP, the light-emitting unit ELP emits light.

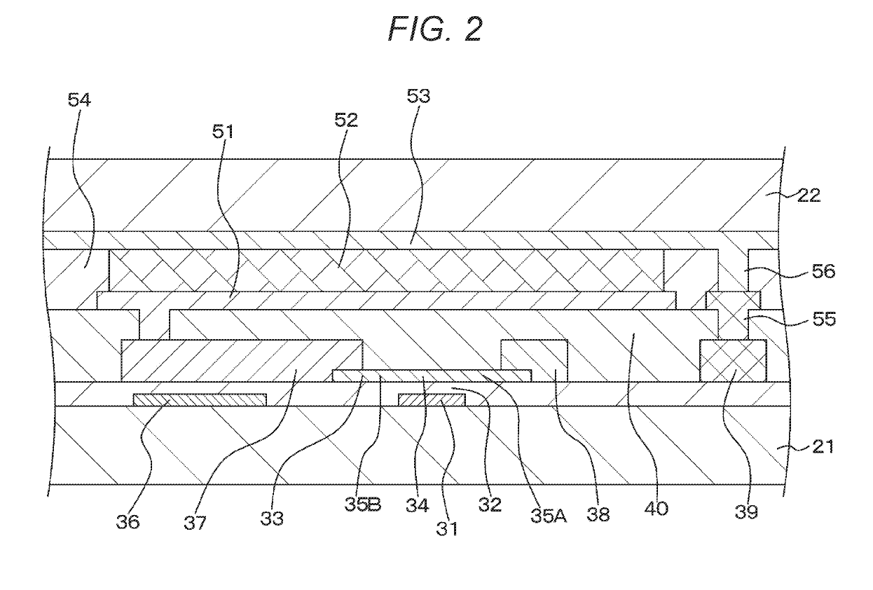

Here, arrangement relationships will be described among the light-emitting unit, the transistor, and the like. FIG. 2 is a schematic partial cross-sectional view of a portion including the display element in the display unit.

The transistors TR_{D} and TR_{W}, and the capacitor C_{S} are formed on a support 21, and the light-emitting unit ELP is formed above the transistors TR_{D} and TR_{W}, and the capacitor C_{S} via an interlayer insulating layer 40, for example. In addition, the other source/drain region of the drive transistor TR_{D} is connected to the anode electrode included in the light-emitting unit ELP via a contact hole. Note that, in FIG. 2, only the drive transistor TR_{D} is illustrated. Other transistors are hidden and invisible.

The drive transistor TR_{D} includes a gate electrode 31, a gate insulating layer 32, one source/drain region 35A provided in a semiconductor layer 33, another source/drain region 35B, and a channel formation region 34 corresponding to a portion of the semiconductor layer 33 between the one source/drain region 35A and the other source/drain region 35B. Meanwhile, the capacitor C_{S} includes one electrode 36, a dielectric layer configured by an extending portion of the gate insulating layer 32, and another electrode 37. The gate electrode 31, a portion of the gate insulating layer 32, and the one electrode 36 configuring the capacitor C_{S} are formed on the support 21. The one source/drain region 35A of the drive transistor TR_{D} is connected to a wiring line 38 (corresponding to the feeder line PS1), and the other source/drain region 35B is connected to the other electrode 37. The drive transistor TR_{D}, the capacitor C_{S}, and the like are covered with the interlayer insulating layer 40, and the light-emitting unit ELP is provided including an anode electrode 51, a hole transporting layer, a light emitting layer, an electron transporting layer, and a cathode electrode 53, on the interlayer insulating layer 40. Note that, in the figure, the hole transporting layer, the light emitting layer, and the electron transporting layer are represented by a single layer 52. A second interlayer insulating layer 54 is provided on a portion of the interlayer insulating layer 40 where the light-emitting unit ELP is not provided, and a transparent substrate 22 is disposed on the second interlayer insulating layer 54 and the cathode electrode 53. Light emitted from the light emitting layer passes through the substrate 22 and is emitted to the outside. Note that, the other electrode 37 and the anode electrode 51 are connected together by the contact hole provided in the interlayer insulating layer 40. In addition, the cathode electrode 53 is connected to a wiring line 39 (corresponding to the common feeder line PS2) provided on the extending portion of the gate insulating layer 32 via contact holes 56 and 55 provided in the second interlayer insulating layer 54 and the interlayer insulating layer 40.

Note that, areas of the electrodes configuring the light-emitting unit ELP are larger than areas of the electrodes configuring the capacitor C_{S}. Generally, a capacitance value is in a relationship of the capacitance C_{EL} of the light-emitting unit ELP>the capacitor C_{S}.

In the light emitting state of the display element 3, the drive transistor TR_{D} illustrated in FIG. 1 is subjected to a voltage setting to operate in a saturation region, and is driven to cause a drain current I_{ds} to flow in accordance with an expression (1) below. As described above, in the light emitting state of the display element 3, the one source/drain region of the drive transistor TR_{D} serves as the drain region and the other source/drain region serves as the source region. For convenience of description, the one source/drain region of the drive transistor TR_{D} may be simply referred to as the drain region and the other source/drain region may be simply referred to as the source region. Note that,

μ: Effective mobility

L: Channel length

W: Channel width

V_{gs}: Voltage of gate electrode with respect to source region (gate-source voltage)

Vₜₕ: Threshold voltage

Cₒₓ: (Relative dielectric constant of gate insulating layer)×(dielectric constant of vacuum)/(thickness of gate insulating layer)

k≡(1/2)·(W/L)·Cₒₓ.

I_{ds}=k·μ·(V_{gs}−Vₜₕ)² (1)

The drain current I_{ds} flows through the light-emitting unit ELP, whereby the light-emitting unit ELP of the display element 3 emits light. Further, intensity of light is controlled in the light-emitting unit ELP when the drain current I_{ds} is flowing, by magnitude of a value of the drain current I_{ds}.

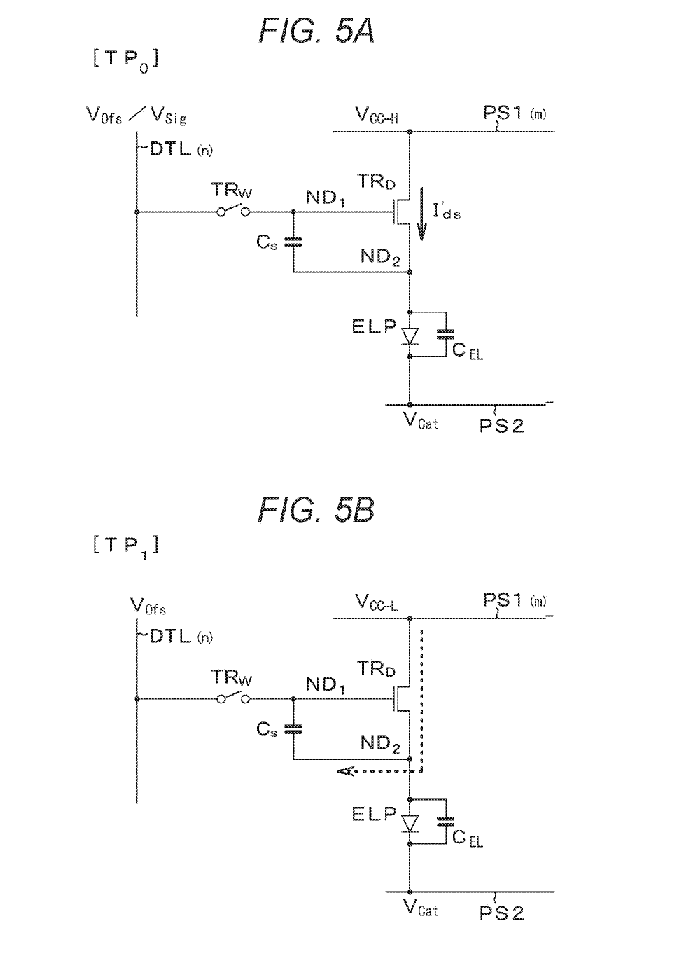

An outline of the display device 1 has been described above. Subsequently, an outline will be described of basic operation of the display device 1. Detailed operation will be described in detail later with reference to FIGS. 5 to 17 as described later.

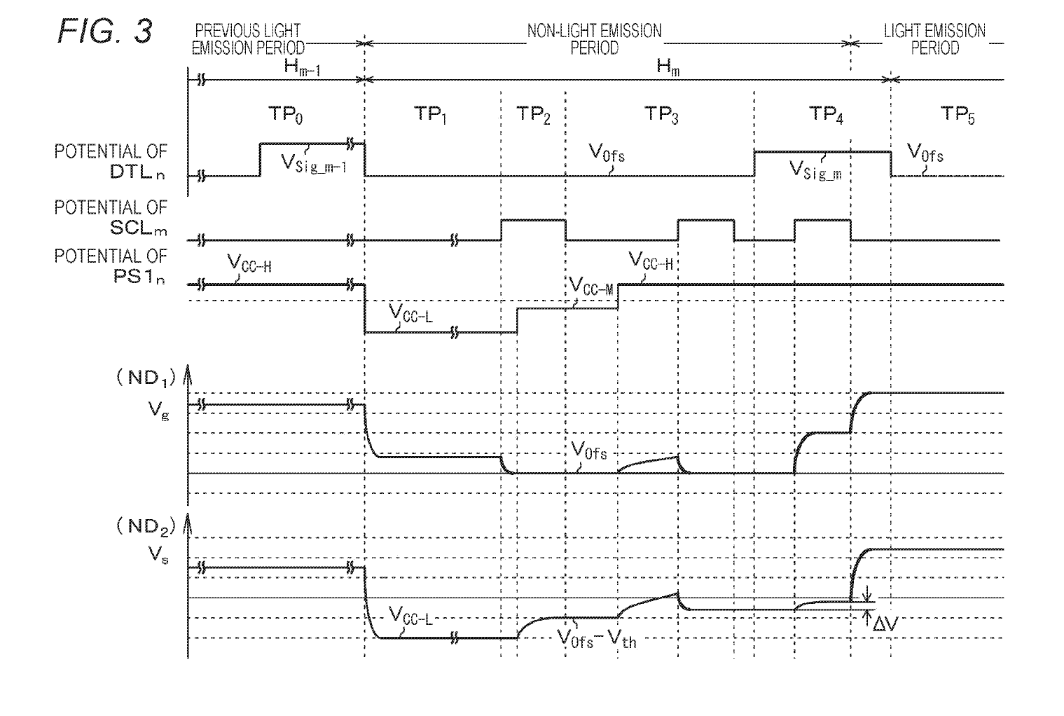

FIG. 3 is a schematic timing chart for explaining operation of the display device according to the first embodiment, more specifically, operation of the (n, m)-th display element of the display device.

The present disclosure, in driving the display element 3 including the n-channel drive transistor TR_{D} in which the voltage is applied to the one source/drain region and the light-emitting unit is connected to the other source/drain region, and the capacitor C_{S} connected between the gate electrode of the drive transistor TR_{D} and the other source/drain region,

performs threshold voltage cancellation processing that applies a drive voltage to the one source/drain region in a state where the reference voltage V_{Ofs} is applied to the gate electrode of the drive transistor TR_{D}, to bring a potential of the other source/drain region closer to a potential obtained by subtracting the threshold voltage Vₜₕ of the drive transistor TR_{D} from the reference voltage V_{Ofs};

subsequently, sets the gate electrode of the drive transistor TR_{D} in the floating state, and changes a potential of the gate electrode in the floating state via parasitic capacitance and causing a current to flow via the drive transistor TR_{D} to increase a voltage between the other source/drain region and the gate electrode, and then applies the reference voltage V_{Ofs} to the gate electrode of the drive transistor TR_{D};

afterwards, performs write processing that applies the video signal voltage V_{Sig} to the gate electrode of the drive transistor TR_{D}; and

subsequently, sets the gate electrode of the drive transistor TR_{D} in the floating state to cause the light-emitting unit to emit light.

Here, in the first embodiment,

the threshold voltage cancellation processing is performed to apply the first drive voltage V_{CC-M} to the one source/drain region in a state where the reference voltage V_{Ofs} is applied to the gate electrode of the drive transistor TR_{D}, to bring the potential of the other source/drain region closer to the potential obtained by subtracting the threshold voltage Vₜₕ of the drive transistor TR_{D} from the reference voltage V_{Ofs}, and

subsequently, the gate electrode of the drive transistor TR_{D} is set in the floating state and the voltage of the one source/drain region of the drive transistor TR_{D} is switched to the second drive voltage V_{CC-H} exceeding the first drive voltage V_{CC-M}, to change the potential of the gate electrode in the floating state via the parasitic capacitance and cause the current to flow via the drive transistor TR_{D}, to increase the voltage between the other source/drain region and the gate electrode, and then the reference voltage V_{Ofs} is applied to the gate electrode of the drive transistor TR_{D}.

In the following description, the values of the voltage or the potential are set as follows, but these are values for the purpose of illustration only and are not limited to these values.

V_{Sig}: Video signal voltage
. . . 0 volts to 15 volts

V_{Ofs}: Reference voltage applied to gate electrode (first node ND₁) of drive transistor TR_{D}
. . . 0 volts

V_{CC-L}: Initialization voltage for initializing potential of another source/drain region (second node ND₂) of drive transistor TR_{D}
. . . −10 volts

V_{CC-M}: First drive voltage supplied during threshold voltage cancellation processing
. . . 10 volts

V_{CC-H}: Second drive voltage for causing current to flow through light-emitting unit ELP
. . . 20 volts

Vₜₕ: Threshold voltage of drive transistor TR_{D}
. . . 3 volts

V_{Cat}: Voltage applied to cathode electrode of light-emitting unit ELP
. . . 0 volts

V_{th-EL}: Threshold voltage of light-emitting unit ELP
. . . 4 volts

A [period-TP₀] illustrated in FIG. 3 is, for example, of operation in a previous display frame, and is a period in which the (n, m)-th display element 3 is in the light emitting state. A drain current flows through the light-emitting unit ELP in the display element 3 configuring the (n, m)-th pixel via the drive transistor TR_{D}.

In a [period-TP₁], the voltage applied to the one source/drain region of the drive transistor TR_{D} is switched from the second drive voltage V_{CC-H} to the initialization voltage V_{CC-L}, whereby the potential of the other source/drain region is initialized.

Specifically, in the beginning period of the [period-TP₁], a voltage of the feeder line PS1ₘ is switched from the drive voltage V_{CC-H} to the initialization voltage V_{CC-L}, and the state is continued until the middle of a [period-TP₂]. Since the drive transistor TR_{D} is in a conductive state, the potential of the other source/drain region of the drive transistor TR_{D} (that is, the potential of the second node ND₂) decreases and is initialized to V_{CC-L}. As the voltage values exemplified, the initialization voltage V_{CC-L} is a voltage set to a predetermined value lower than a voltage obtained by subtracting the threshold voltage Vₜₕ of the drive transistor TR_{D} from the reference voltage V_{Ofs}. Since the write transistor TR_{W} is in the non-conductive state and the first node ND₁ and the second node ND₂ are connected together via the capacitor, the potential of the first node ND₁ also decreases with potential decrease in the second node ND₂.

Then, in the [period-TP₂], the threshold voltage cancellation processing is performed to apply the drive voltage (in the first embodiment, the first drive voltage V_{CC-M}) to the one source/drain region in a state where the reference voltage V_{Ofs} is applied to the gate electrode of the drive transistor TR_{D}, to bring the potential of the other source/drain region closer to the potential obtained by subtracting the threshold voltage Vₜₕ of the drive transistor TR_{D} from the reference voltage V_{Ofs}.

Specifically, from the beginning period to the end period of the [period-TP₂], the reference voltage V_{Ofs} is applied to the gate electrode of the drive transistor TR_{D} from the data line DTLₙ via the write transistor TR_{W} set in the conductive state on the basis of the scanning signal from the scanning line SCL. In addition, in the middle of the [period-TP₂], the voltage of the feeder line PS1ₘ is switched from the reference voltage V_{Ofs} to the first drive voltage V_{CC-M}.

Since the gate-source voltage of the drive transistor TR_{D} exceeds the threshold voltage Vₜₕ, the current flows through the drive transistor TR_{D} and the potential of the other source/drain region increases. As a result, the potential of the second node ND₂ is brought to be closer to the potential obtained by subtracting the threshold voltage Vₜₕ of the drive transistor TR_{D} from the reference voltage V_{Ofs}. If the potential of the second node ND₂ reaches (V_{Ofs}−Vₜₕ), the drive transistor TR_{D} is in a non-conductive state.

Then, in the [period-TP₂], the gate electrode of the drive transistor TR_{D} is set in the floating state, and the potential of the gate electrode in the floating state is changed via the parasitic capacitance and the current is caused to flow via the drive transistor TR_{D}, to increase the voltage between the other source/drain region and the gate electrode, and then the reference voltage V_{Ofs} is applied to the gate electrode of the drive transistor TR_{D}.

Specifically, in a [period-TP₃], the gate electrode of the drive transistor TR_{D} is set in the floating state and the voltage of the one source/drain region of the drive transistor TR_{D} is switched to the second drive voltage V_{CC-H} exceeding the first drive voltage to increase the voltage between the other source/drain region and the gate electrode, and then the reference voltage V_{Ofs} is applied to the gate electrode of the drive transistor TR_{D}.

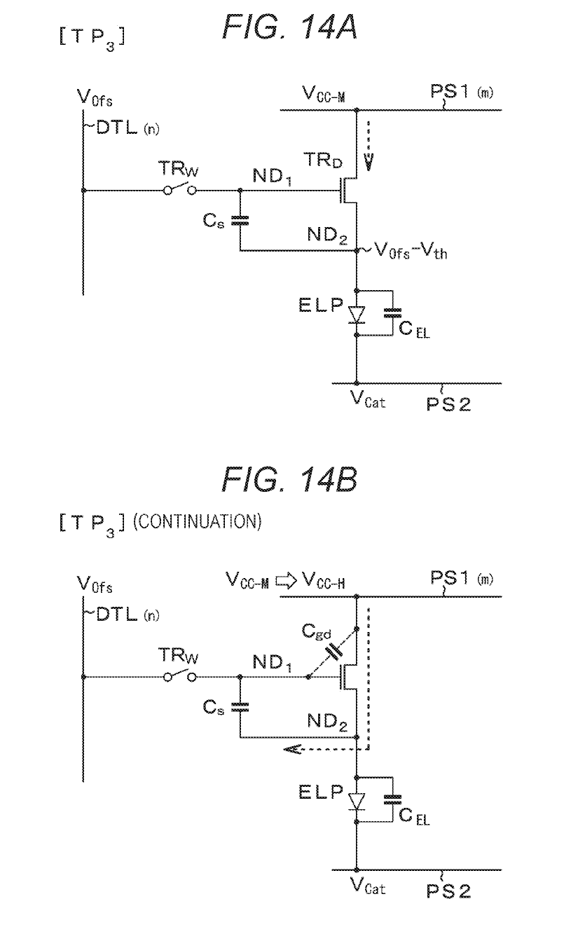

In the beginning period of the [period-TP₃], the write transistor TR_{W} is in the non-conductive state. In the middle of the [period-TP₃], the voltage of the feeder line PS1ₘ is switched from the first drive voltage V_{CC-M} to the second drive voltage V_{CC-H}. As will be described in detail later with reference to FIG. 14B, since there is the parasitic capacitance between the gate electrode and the one source/drain region of the drive transistor TR_{D}, the potential of the gate electrode also increases with the voltage increase in the feeder line PS1ₘ. As a result, the drive transistor TR_{D} is in the conductive state, and the potential of the other source/drain region increases. Then, the voltage of the gate electrode of the drive transistor TR_{D}, in other words, the voltage of the first node ND₁ also increases due to bootstrap operation.

After that, the reference voltage V_{Ofs} is applied to the gate electrode of the drive transistor TR_{D} from the data line DTLₙ via the write transistor TR_{W} set in the conductive state on the basis of the scanning signal from the scanning line SCL. The potential of the gate electrode of the drive transistor TR_{D} decreases to V_{Ofs} to be initialized, and the potential of the second node ND₂ also decreases.

During a [period-TP₄], the video signal voltage V_{Sig}_{_}ₘ is supplied to the data line DTLₙ. During this period, write processing is performed that applies the video signal voltage to the gate electrode of the drive transistor TR_{D}. Specifically, the write transistor TR_{W} is set in the conductive state on the basis of the scanning signal of the scanning line SCLₘ, and the video signal voltage V_{Sig}_{_}ₘ is applied to the gate electrode of the write transistor TR_{W} from the data line DTLₙ.

In this write processing, the current flows through the drive transistor TR_{D}, whereby the potential of the other source/drain region of the drive transistor TR_{D} changes. That is, since the video signal voltage V_{Sig} is applied to the gate electrode of the drive transistor TR_{D} in a state where the second drive voltage V_{CC-H} is applied to the one source/drain region of the drive transistor TR_{D}, the current flows via the drive transistor TR_{D}, and the potential of the second node ND₂ changes. Specifically, the potential of the second node ND₂ increases.

Subsequently, the gate electrode of the drive transistor TR_{D} is set in the floating state, whereby the light-emitting unit ELP emits light. Specifically, if the scanning signal of the scanning line SCLₘ ends, the write transistor TR_{W} is set in the non-conductive state, and the gate electrode of the drive transistor TR_{D} is disconnected from the data line DTLₙ. The second drive voltage V_{CC-H} is applied to the one source/drain region of the drive transistor TR_{D}, and the first node ND₁ is electrically disconnected from the data line DTLₙ. Then, a current according to a value of the voltage held by the capacitor C_{S} due to the write processing flows through the light-emitting unit ELP via the drive transistor TR_{D}. As a result of the above, the potential of the second node ND₂ increases.

Here, as described above, the gate electrode of the drive transistor TR_{D} is in the floating state and moreover the capacitor C_{S} exists, so that a phenomenon similar to that in a so-called bootstrap circuit occurs in the gate electrode of the drive transistor TR_{D}, and the potential of the first node ND₁ also increases.

The outline of the basic operation of the display device 1 has been described above.

As will be described in detail later, a voltage change of the other source/drain region of the drive transistor TR_{D} due to the operation in the [period-TP₃] illustrated in FIG. 3, reduces a phenomenon that the voltage of the capacitor C_{S} decreases due to the bootstrap operation as the threshold voltage Vₜₕ increases in the [period-TP₄] to a [period-TP₅].

Here, to facilitate understanding of operation characterizing the first embodiment, operation and problems will be described in detail in a reference example in which the characteristic operation is omitted.

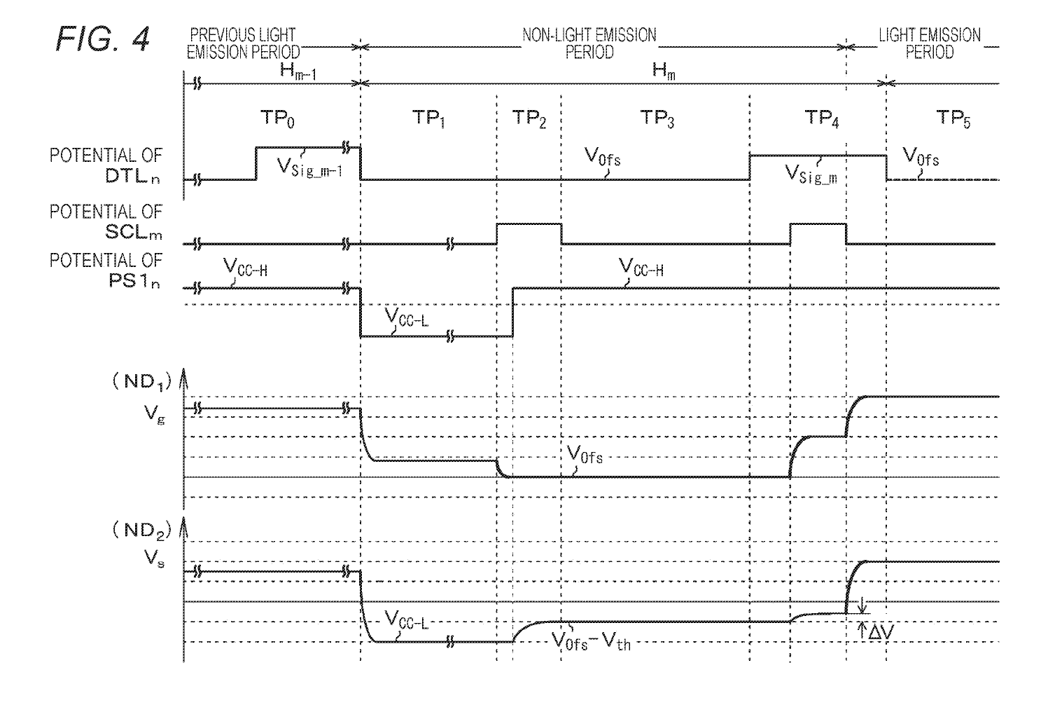

FIG. 4 is a schematic timing chart for explaining operation of a display device of the reference example in which the first drive voltage V_{CC-M} applied to the feeder line in the [period-TP₂] and the [period-TP₃] of FIG. 3 is set to the second drive voltage V_{CC-H}, and a pulse applied to the scanning line in the [period-TP₃] is omitted.

[Period-TP₀] (See FIGS. 4 and 5A)

This [period-TP₀] is, for example, of operation in a previous display frame, and is a period in which the (n, m)-th display element 3 is in the light emitting state after completion of the previous various types of processing. That is, the second drive voltage V_{CC-H} is supplied to the feeder line PS1ₘ, and a drain current I_{ds}′ based on an expression (5) as described later flows through the light-emitting unit ELP in the display element 3 configuring the (n, m)-th pixel, and a luminance of the display element 3 configuring the (n, m)-th pixel is a value corresponding to the drain current I_{ds}′. Here, the write transistor TR_{W} is in the non-conductive state, and the drive transistor TR_{D} is in the conductive state.

As described above, corresponding to each horizontal scanning period, the reference voltage V_{Ofs} and the video signal voltage V_{Sig} are supplied to the data line DTLₙ. However, since the write transistor TR_{W} is in the non-conductive state, even if a potential (voltage) of the data line DTLₙ changes in the [period-TP₀], the potentials of the first node ND₁ and the second node ND₂ do not change (actually, a potential change may occur due to electrostatic coupling of the parasitic capacitance or the like, but these can usually be ignored).

[Period-TP₁] (See FIGS. 4 and 5B)

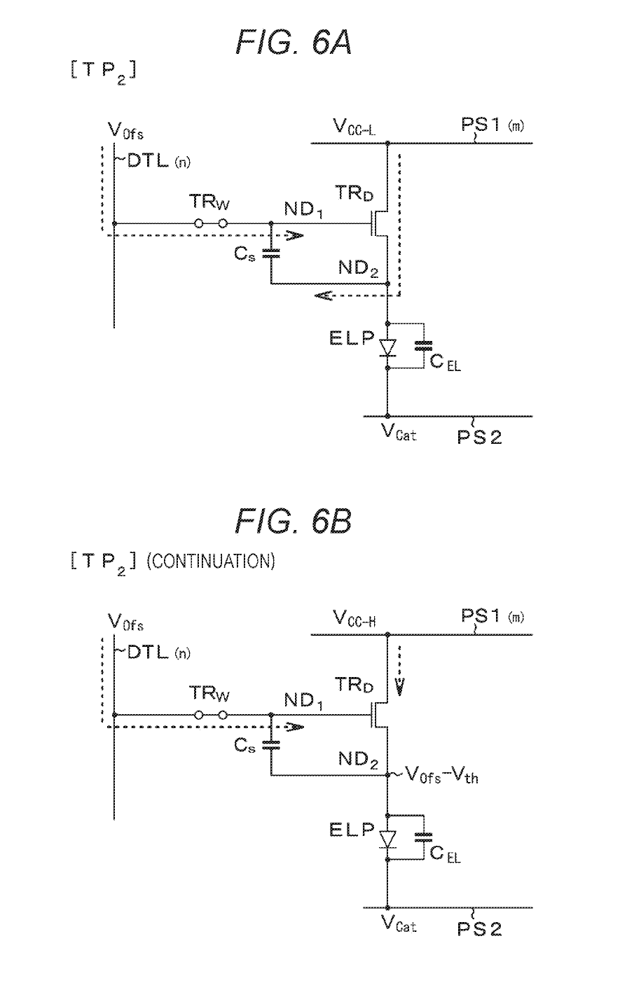

This [period-TP₁] is, for example, of operation in a current display frame. In the beginning period of the [period-TP₀], the voltage supplied to the feeder line PS1ₘ is switched from the second drive voltage V_{CC-H} to the initialization voltage V_{CC-L}. As a result, the potential of the second node ND₂ decreases to V_{CC-L}, and a reverse voltage is applied between the anode electrode and the cathode electrode of the light-emitting unit ELP, and the light-emitting unit ELP is in a non-light emitting state. In addition, the potential of the first node ND₁ (the gate electrode of the drive transistor TR_{D}) in the floating state also decreases to follow the potential decrease in the second node ND₂.

[Period-TP₂] (See FIGS. 4, 6A, and 6B)

In this [period-TP₂], the scanning line SCLₘ is set to a high level to set the write transistor TR_{W} in the conductive state. Since the reference voltage V_{Ofs} is supplied to the data line DTLₙ, the potential of the first node ND₁ is V_{Ofs} (0 volts) (see FIG. 6A). Then, the voltage supplied to the feeder line PS1ₘ is switched from the initialization voltage V_{CC-L} to the second drive voltage V_{CC-H}. As a result, the potential of the second node ND₂ increases to the potential obtained by subtracting the threshold voltage Vₜₕ of the drive transistor TR_{D} from the reference voltage V_{Ofs}.

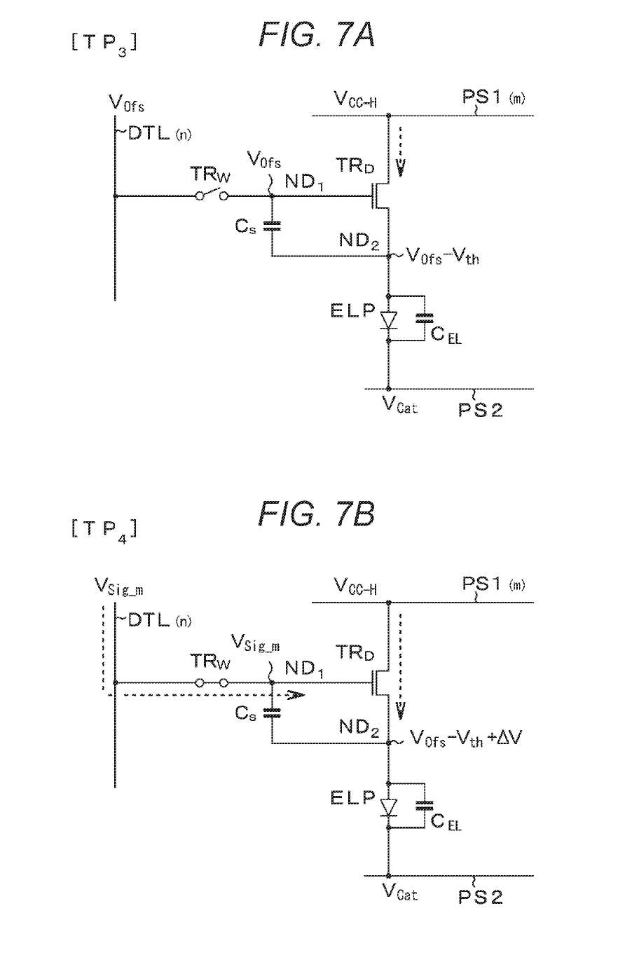

If this [period-TP₂] is sufficiently long, a potential difference between the gate electrode of the drive transistor TR_{D} and the other source/drain region reaches Vₜₕ, and the drive transistor TR_{D} is in the non-conductive state. That is, the potential of the second node ND₂ is brought to be closer to (V_{Ofs}−Vₜₕ) and finally is (V_{Ofs}−Vₜₕ) (see FIG. 6B).

[Period-TP₃] (See FIGS. 4 and 7A)

In this [period-TP₃], the scanning line SCLₘ is set to a low level, and the write transistor TR_{W} is set in the non-conductive state. As a result, the first node ND₁ is in the floating state. If the drive transistor TR_{D} has reached the non-conductive state in the [period-TP₂], the potentials of the first node ND₁ and the second node ND₂ do not substantially change (actually, a potential change may occur due to electrostatic coupling of the parasitic capacitance or the like, but these can usually be ignored). Note that, in a case where the drive transistor TR_{D} has not reached the non-conductive state in the threshold voltage cancellation processing, the bootstrap operation occurs, and the potentials of the first node ND₁ and the second node ND₂ increase somewhat.

[Period-TP₄] (See FIGS. 4, 7B, and 8A)

In this [period-TP₄], the video signal voltage V_{Sig}_{_}ₘ is supplied to the data line DTLₙ. Then, on the basis of the scanning signal of the scanning line SCLₘ, the write transistor TR_{W} is set in the conductive state, and the video signal voltage V_{Sig}_{_}ₘ is applied to the gate electrode of the drive transistor TR_{D} via the write transistor TR_{W}.

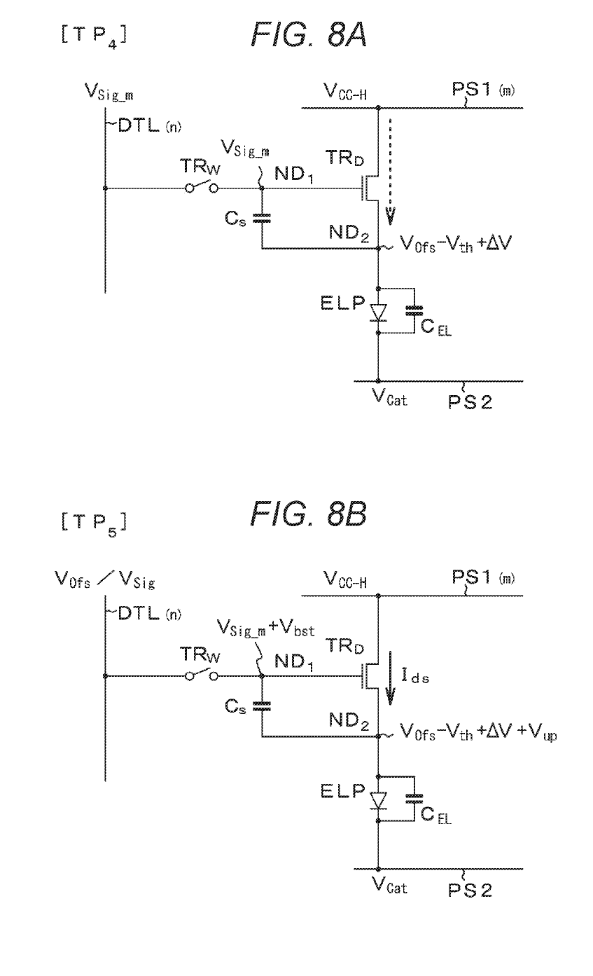

In the write processing described above, the second drive voltage V_{CC-H} is applied to the one source/drain region of the drive transistor TR_{D}. For this reason, as illustrated in FIG. 4, the potential of the second node ND₂ increases. An amount of increase in the potential is represented by a reference sign ΔV (see FIG. 7B). After ending the write processing, on the basis of the scanning signal of the scanning line SCLₘ, the write transistor TR_{W} is set in the non-conductive state (see FIG. 8A).

When a potential of the gate electrode (the first node ND₁) of the drive transistor TR_{D} is represented as V_{g}, and a potential of the source region (the second node ND₂) of the drive transistor TR_{D} is represented as Vₛ, if the amount of increase ΔV in the potential of the second node ND₂ is not considered, a value of V_{g} and a value of Vₛ are as follows. The potential difference between the first node ND₁ and the second node ND₂, that is, the potential difference V_{gs} between the other source/drain region serving as the source region and the gate electrode of the drive transistor TR_{D} can be expressed by an expression (2) below.

V_{g}=V_{Sig}_{_}ₘ

Vₛ≈V_{Ofs}−Vₜₕ

V_{gs}≈V_{Sig}_{_}ₘ(V_{Ofs}−Vₜₕ) (2)

The potential difference V_{gs} obtained in the write processing to the drive transistor TR_{D} depends only on the video signal voltage V_{Sig}_{_}ₘ for controlling the luminance in the light-emitting unit ELP, the threshold voltage Vₜₕ of the drive transistor TR_{D}, and the reference voltage V_{Ofs}.

Subsequently, the amount of increase (ΔV) in the potential of the second node ND₂ will be described. In the method for driving described above, the write processing is performed in a state where the drive voltage V_{CC-H} is applied to the one source/drain region of the drive transistor TR_{D} of the display element 3. As a result, mobility correction processing is also performed that changes the potential of the other source/drain region of the drive transistor TR_{D} of the display element 3.

In a case where the drive transistor TR_{D} is manufactured from a thin film transistor or the like, it is difficult to avoid that variation occurs in the mobility μ between the transistors. Even if the video signal voltages V_{Sig} having the same value are applied to the gate electrodes of multiple drive transistors TR_{D} having differences in the mobility μ, a difference occurs between the drain current I_{ds} flowing through the drive transistor TR_{D} whose mobility μ is large and the drain current I_{ds} flowing through the drive transistor TR_{D} whose mobility μ is small, and homogeneity (uniformity) is degraded of a screen of the display device 1.

In the method for driving described above, in a case where the value is large of the mobility μ of the drive transistor TR_{D}, the amount of increase ΔV is large of the potential of the other source/drain region of the drive transistor TR_{D} (that is, the potential of the second node ND₂). Conversely, in a case where the value is small of the mobility μ of the drive transistor TR_{D}, the amount of increase ΔV is small of the potential of the other source/drain region of the drive transistor TR_{D}. Here, the potential difference V_{gs} between the other source/drain region serving as the source region and the gate electrode of the drive transistor TR_{D} is modified from the expression (2) to an expression (3) below.

V_{gs}≈V_{Sig}_{_}ₘ(V_{Ofs}−Vₜₕ)−ΔV (3)

Note that, length of a period of the scanning signal for writing the video signal voltage V_{Sig} only needs to be determined in accordance with a design of the display element 3 and the display device 1. In addition, the length of the period of the scanning signal is determined such that the potential (V_{Ofs}−Vₜₕ+ΔV) in the other source/drain region of the drive transistor TR_{D} at this time satisfies an expression (4) below. If this condition is satisfied, the light-emitting unit ELP does not emit light in the write processing. Note that, with this mobility correction processing, correction of variation of the coefficient k(≡(1/2)·(W/L)·Cₒₓ) in the expression (1) is also performed at the same time.

(V_{Ofs}−Vₜₕ+ΔV)<(V_{th-EL}+V_{Cat}) (4)

[Period-TP₅] (See FIGS. 4 and 8B)

The second drive voltage V_{CC-H} is applied to the one source/drain regions of the drive transistor TR_{D}, and the write transistor TR_{W} maintains the non-conductive state from the end of the write processing. As a result of the above, the potential of the second node ND₂ increases. The amount of increase in the potential at this time is represented by a reference sign Vᵤₚ.

The gate electrode of the drive transistor TR_{D} is in the floating state and moreover the capacitor C_{S} exists, so that the phenomenon similar to that in the so-called bootstrap circuit occurs in the gate electrode of the drive transistor TR_{D}, and the potential of the first node ND₁ also increases. The amount of increase in the potential at this time is represented by a reference sign V_{bst}. If the bootstrap operation is ideal, since Vᵤₚ=V_{bst}, a value of the gate-source voltage V_{gs} holds a value of the expression (3).

Since the potential of the second node ND₂ increases and exceeds (V_{th-EL}+V_{Cat}), the light-emitting unit ELP starts light emission. At this time, since a current flowing through the light-emitting unit ELP is the drain current I_{ds} flowing from the drain region to the source region of the drive transistor TR_{D}, the current can be expressed by the expression (1). Here, from the expressions (1) and (3), the expression (1) can be modified into the expression (5) below.

I_{ds}=k·p·(V_{Sig}_{_}ₘ−V_{Ofs}−ΔV)² (5)

Therefore, in a case where the reference voltage V_{Ofs} is set to 0 volts, the current I_{ds} flowing through the light-emitting unit ELP is proportional to the square of a value obtained by subtracting a value of the potential correction value ΔV due to the mobility μ of the drive transistor TR_{D} from a value of the video signal voltage V_{Sig}_{_}ₘ for controlling the luminance in the light-emitting unit ELP. Therefore, since the current I_{ds} flowing through the light-emitting unit ELP does not depend on the threshold voltage Vₜₕ of the drive transistor TR_{D}, an amount of light emission (luminance) of the light-emitting unit ELP is not influenced by the threshold voltage Vₜₕ of the drive transistor TR_{D}. Furthermore, the luminance of the (n, m)-th display element 3 is a value corresponding to the current I_{ds}.

Moreover, since the potential correction value ΔV is larger for the drive transistor TR_{D} whose mobility μ is larger, the value of V_{gs} on the left side of the expression (3) is smaller. Therefore, in the expression (4), the value of (V_{Sig}_{_}ₘ−V_{Ofs}−ΔV)² is small even if the value of mobility μ is large, so that it is possible to correct variation in the drain current I_{ds} caused by variation in the mobility μ of the drive transistor TR_{D} (further, variation in k). As a result, it is possible to correct variation in the luminance of the light-emitting unit ELP caused by the variation in the mobility μ (further, the variation in k).

The operation of the reference example has been described in detail above. Subsequently, the problems of the reference example will be described in detail.

As described above, if the bootstrap operation in the [period-TP₄] to the [period-TP₅] in FIG. 4 is ideal, the value of the gate-source voltage V_{gs} holds the value of the expression (3). Therefore, the current flowing during light emission is not influenced by the threshold voltage Vₜₕ.

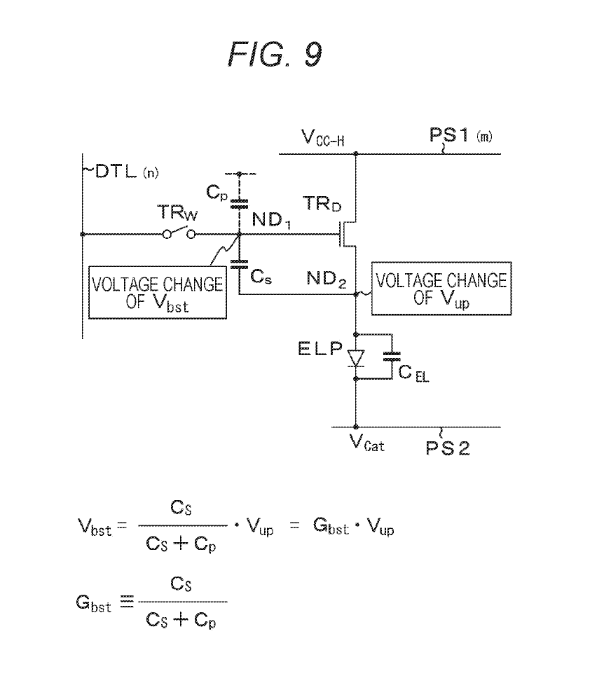

However, in the bootstrap operation, behavior is exhibited, such as Vᵤₚ>V_{bst}, actually. As a result, the value of the gate-source voltage V_{gs} after the bootstrap operation is influenced by the threshold voltage Vₜₕ. Detailed description will be made with reference to FIGS. 9 to 12 below.

Note that, for convenience of description, the potential change ΔV of the second node ND₂ in the write processing is not considered.

FIG. 9 is a diagram for explaining a bootstrap gain G_{bst} indicating a ratio of a gate voltage change to a source voltage change of the drive transistor in the bootstrap operation in the [period-TP₄] to the [period-TP₅] illustrated in FIG. 4.

There is parasitic capacitance occurring between the gate electrode of the transistor and various wiring lines and the like. In FIG. 9, the parasitic capacitance is represented by a reference sign Cₚ.

In this case, the voltage change V_{bst} of the first node ND′ when the voltage change of Vᵤₚ occurs in the second node ND₂ is given by an expression (6) below.

$$\begin{matrix}{V}_{bst} = \{ Cs / ( Cs + Cp ) \} \cdot {V}_{up} \\ = {G}_{bst} \cdot {V}_{up}\end{matrix} \qquad ( 6 )$$

However, G_{bst}≡C_{S}/(C_{S}+Cₚ), and is hereinafter referred to as a bootstrap gain.

If a value of the parasitic capacitance Cₚ is sufficiently small with respect to the capacitor C_{S}, the bootstrap gain G_{bst} can be treated substantially as “1”. However, as the display element is miniaturized, the area of the electrode configuring the capacitor C_{S} has to be reduced, and as a result, influence of the parasitic capacitance Cₚ increases.

Here, the voltage change will be described in a case where the bootstrap gain G_{bst} is “1”, and in a case where G_{bst} is “0.6”, for example, as an example of a case where the bootstrap gain G_{bst} is smaller than 1.

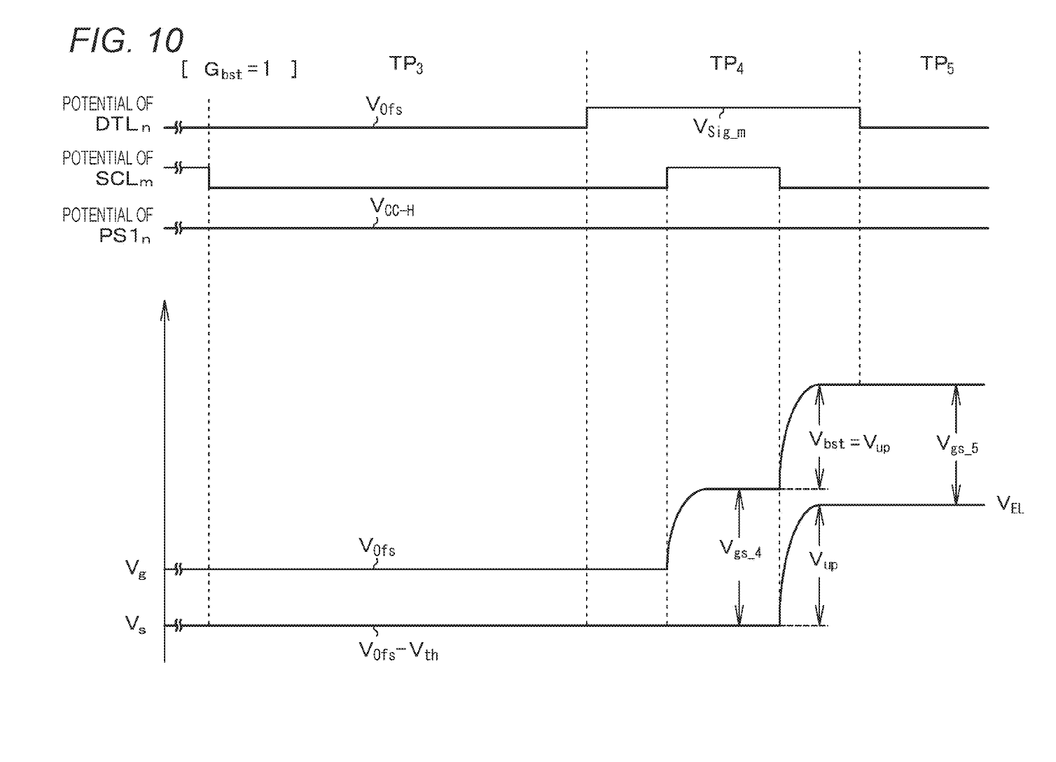

FIG. 10 is a schematic timing chart for explaining the operation when the bootstrap gain G_{bst} is “1”.

In FIG. 10, if the gate-source voltage at the time of the write processing in the [period-TP₄] is represented as V_{gs}_{_}₄, the voltage is expressed as V_{gs}_{_}₄=V_{Sig}_{_}ₘ−(V_{Ofs}−Vₜₕ).

In addition, if the voltage of the anode electrode of the light-emitting unit ELP during light emission is represented by a reference sign V_{EL}, the amount of voltage increase Vᵤₚ of the source region of the drive transistor TR_{D} is expressed as Vᵤₚ=V_{EL} (V_{Ofs}−Vₜₕ).

Then, the amount of voltage increase V_{bst} of the gate electrode due to the bootstrap operation is V_{bst}=G_{bst}·Vᵤₚ=Vᵤₚ.

Therefore, if the gate-source voltage after the bootstrap operation in the [period-TP₄] to the [period-TP₅] is represented as V_{gs}_{_}₅, the voltage is

$$\begin{matrix}{V}_{gs \_ 5} = {V}_{Sig \_ 4} \\ = {V}_{Sig \_ m} - ( {V}_{Ofs} - {V}_{th} ) .\end{matrix}$$

As described above, in the case where the bootstrap gain G_{bst} is “1”, the gate-source voltage does not change before and after the bootstrap operation.

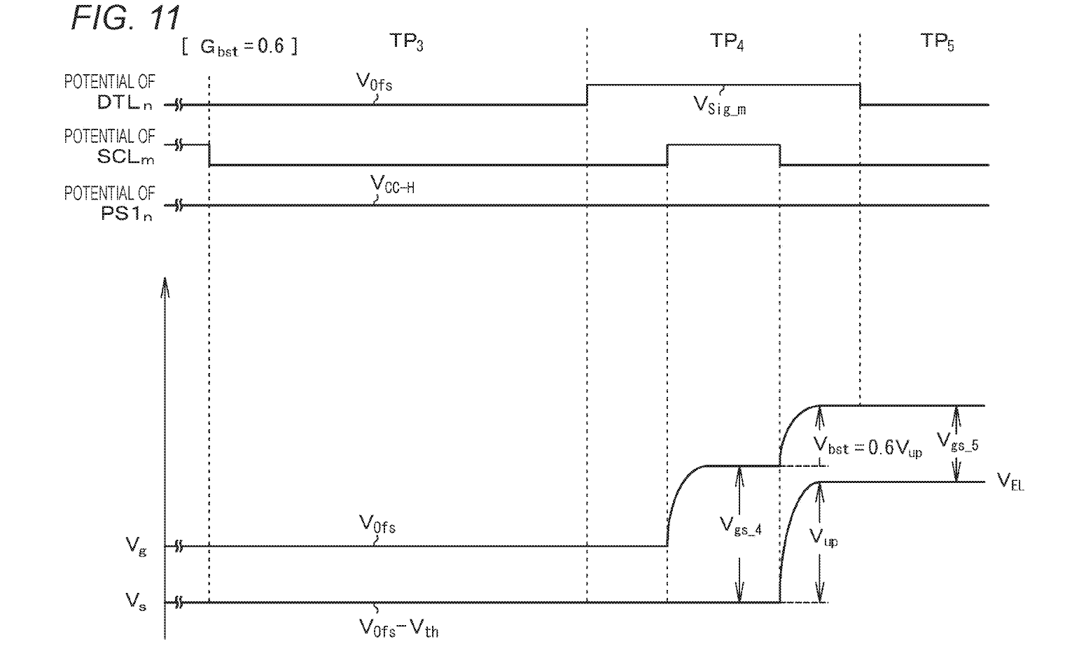

Subsequently, a case of FIG. 11 will be described. Also in the case of FIG. 11, the gate-source voltage V_{gs}_{_}₄ during the write processing in the [period-TP₄] is V_{gs}_{_}₄=V_{Sig}_{_}ₘ−(V_{Ofs}−Vₜₕ), similar to the case of FIG. 10, and the amount of voltage increase Vᵤₚ of the source region of the drive transistor TR_{D} is also Vᵤₚ=V_{EL}−(V_{Ofs}−Vₜₕ).

However, in the case of FIG. 11, the amount of voltage increase V_{bst} of the gate electrode due to the bootstrap operation is V_{bst}=G_{bst}·Vᵤₚ=0.6×Vᵤₚ.

Therefore, the gate-source voltage V_{gs}_{_}₅ after the bootstrap operation is

$$\begin{matrix}{V}_{gs \_ 5} = {V}_{Sig \_ 4} - ( {V}_{up} - 0.6 \times {V}_{up} ) \\ = {V}_{Sig \_ 4} - {V}_{up} \cdot ( 1 - 0.6 ) \\ = {V}_{Sig \_ m} ( {V}_{Ofs} - {V}_{th} ) - ( {V}_{EL} - ( {V}_{Ofs} - {V}_{th} ) ) \cdot ( 1 - 0.6 ) .\end{matrix}$$

Therefore, in the case where the bootstrap gain G_{bst} is smaller than 1, an amount of decrease in the gate-source voltage in the bootstrap operation is expressed as (V_{EL}−(V_{Ofs}−Vₜₕ))·(1−G_{bst}) (7). Since an example is described in which G_{bst} is “0.6”, more specifically, the amount of decrease is expressed as (V_{EL}−(V_{Ofs}−Vₜₕ))−(1−0.6).

This expression (7) includes the threshold voltage Vₜₕ. Therefore, if the threshold voltage Vₜₕ varies, the amount of decrease in the gate-source voltage due to the bootstrap operation also varies.

For this reason, even if the voltage is held in the capacitor Cₛ to cancel influence of the threshold voltage Vₜₕ in the write processing in the [period-TP₄], the luminance varies due to variation in the amount of decrease in the gate-source voltage due to the bootstrap operation.

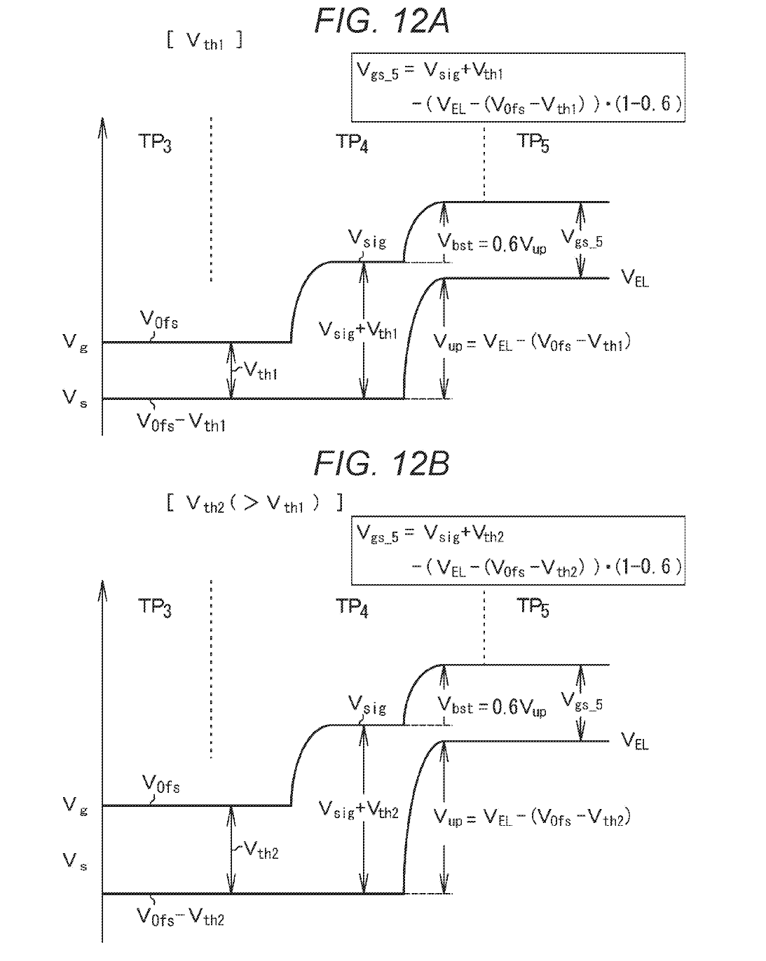

FIGS. 12A and 12B are diagrams each explaining the value of the gate-source voltage V_{gs} of the drive transistor in the [period-TP₄] and the [period-TP₅], and FIG. 12A illustrates a case where the threshold voltage of the transistor is Vₜₕ₁, and FIG. 12B illustrates a case where the threshold voltage of the drive transistor is Vₜₕ₂ (>Vₜₕ₁).

As apparent from the figure, the amount of voltage increase Vᵤₚ of the source region of the drive transistor TR_{D} increases as the threshold voltage Vₜₕ increases. As a result, the amount of decrease in the gate-source voltage in the bootstrap operation also increases as the threshold voltage Vₜₕ increases. In a case where the threshold voltages are Vₜₕ₁ and Vₜₕ₂, a difference of (1−0.6)·(Vₜₕ₂−Vₜₕ₁) occurs in the amount of decrease in the gate-source voltage in the bootstrap operation. Qualitatively, a phenomenon occurs that the luminance of the display element is darker as the threshold voltage Vₜₕ increases.

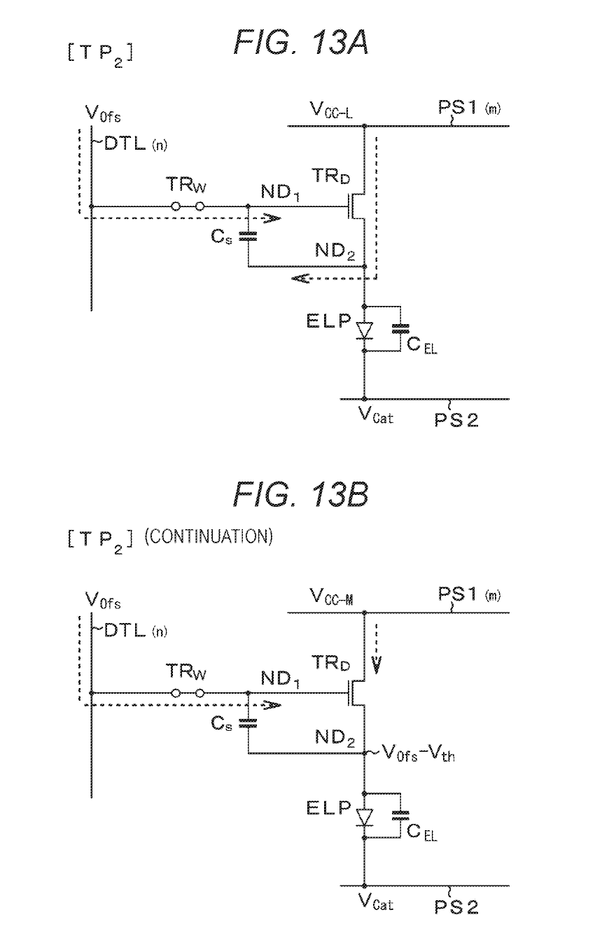

The problems of the reference example have been described in detail above. Subsequently, the operation characterizing the first embodiment will be described in detail with reference to FIG. 3, and FIGS. 13 to 17.

As illustrated in FIG. 3, in the first embodiment, the first drive voltage V_{CC-M} is applied to the feeder line PS1ₘ in the [period-TP₂] and the [period-TP₃].

At this time, although a value of the drive voltage supplied to the feeder line PS1ₘ is different from the value of the reference example, as will be described below, similarly to the reference example, threshold voltage cancellation processing is performed to bring the potential of the other source/drain region closer to the potential obtained by subtracting the threshold voltage Vₜₕ of the drive transistor TR_{D} from the reference voltage V_{Ofs}.

[Period-TP₂] (See FIGS. 3, 13A, and 13B)

In the [period-TP₂], the scanning line SCLₘ is set to the high level to set the write transistor TR_{W} in the conductive state. Since the reference voltage V_{Ofs} is supplied to the data line DTLₙ, the potential of the first node ND₁ is V_{Ofs} (0 volts) (see FIG. 13A). Then, the voltage supplied to the feeder line PS1ₘ is switched from the initialization voltage V_{CC-L} to the first drive voltage V_{CC-M}. As a result, the potential of the second node ND₂ increases to the potential obtained by subtracting the threshold voltage Vₜₕ of the drive transistor TR_{D} from the reference voltage V_{Ofs}.

If this [period-TP₂] is sufficiently long, a potential difference between the gate electrode of the drive transistor TR_{D} and the other source/drain region reaches Vₜₕ, and the drive transistor TR_{D} is in the non-conductive state. That is, the potential of the second node ND₂ is brought to be closer to (V_{Ofs}−Vₜₕ) and finally is (V_{Ofs}−Vₜₕ) (see FIG. 13B).

[Period-TP₃] (See FIGS. 3, 14A, 14B, 15A, and 15B)

In this [period-TP₃], the scanning line SCLₘ is set to the low level, and the write transistor TR_{W} is set in the non-conductive state. As a result, the first node ND₁ is in the floating state. If the drive transistor TR_{D} has reached the non-conductive state in the [period-TP₂], the potentials of the first node ND₁ and the second node ND₂ do not substantially change (see FIG. 14A). The operation up to this point is similar to the operation of the reference example.

In the first embodiment, the voltage of the feeder line PS1ₘ is switched from the first drive voltage V_{CC-M} to the second drive voltage V_{CC-H}, in the middle of the [period-TP₃] (see FIG. 14B). Here, since there is parasitic capacitance (represented by a reference sign C_{gd}) between the one source/drain region and the gate electrode of the drive transistor TR_{D}, the potential of the gate electrode also increases due to capacitive coupling. As a result, since the gate-source voltage of the drive transistor TR_{D} exceeds the threshold voltage Vₜₕ, the current flows via the drive transistor TR_{D}, and the potential of the second node ND₂ increases. Then, the voltage of the gate electrode of the drive transistor TR_{D}, in other words, the voltage of the first node ND₁ also increases due to bootstrap operation.

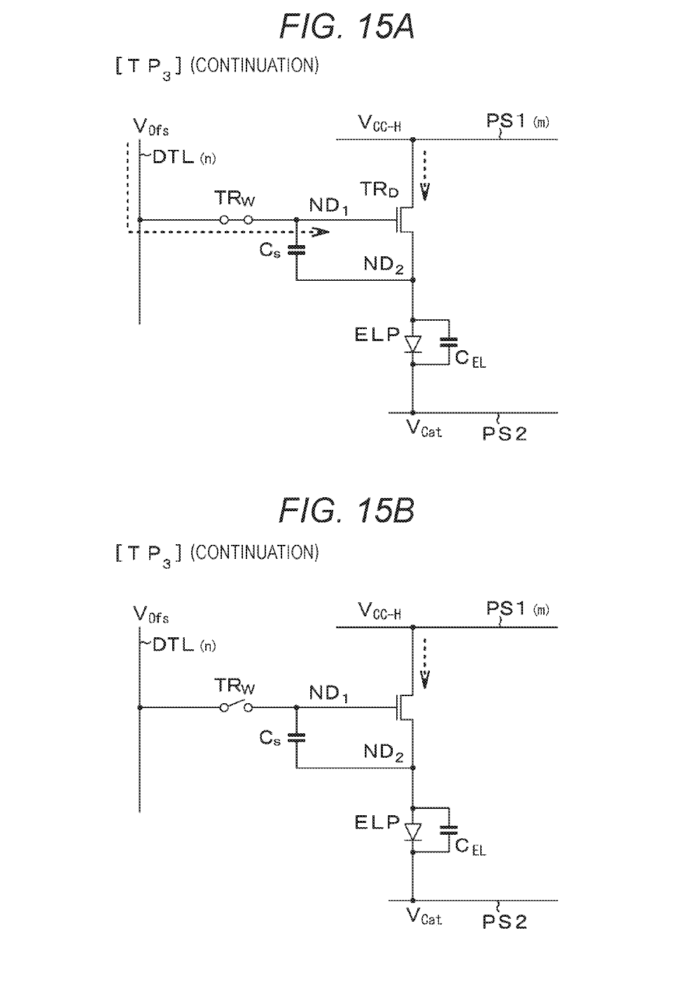

After that, the reference voltage V_{Ofs} is applied to the gate electrode of the drive transistor TR_{D} from the data line DTLₙ via the write transistor TR_{W} set in the conductive state on the basis of the scanning signal from the scanning line SCL. The potential of the other source/drain region of the drive transistor TR_{D} decreases and is initialized to V_{CC-L} again. The potential of the second node ND₂ also decreases. As a result, the drive transistor TR_{D} is set in the non-conductive state (see FIG. 15A). After that, the write transistor TR_{W} is set in the non-conductive state, but the drive transistor TR_{D} keeps the non-conductive state (see FIG. 15B).

Since the operation after the [period-TP₄] is similar to the operation described in the reference example, the description will be omitted.

The operation characterizing the first embodiment described above is performed, whereby luminance unevenness is reduced in which the amount of decrease in the gate-source voltage in the bootstrap operation is caused by variation in the threshold voltage Vₜₕ. Detailed description will be made below.

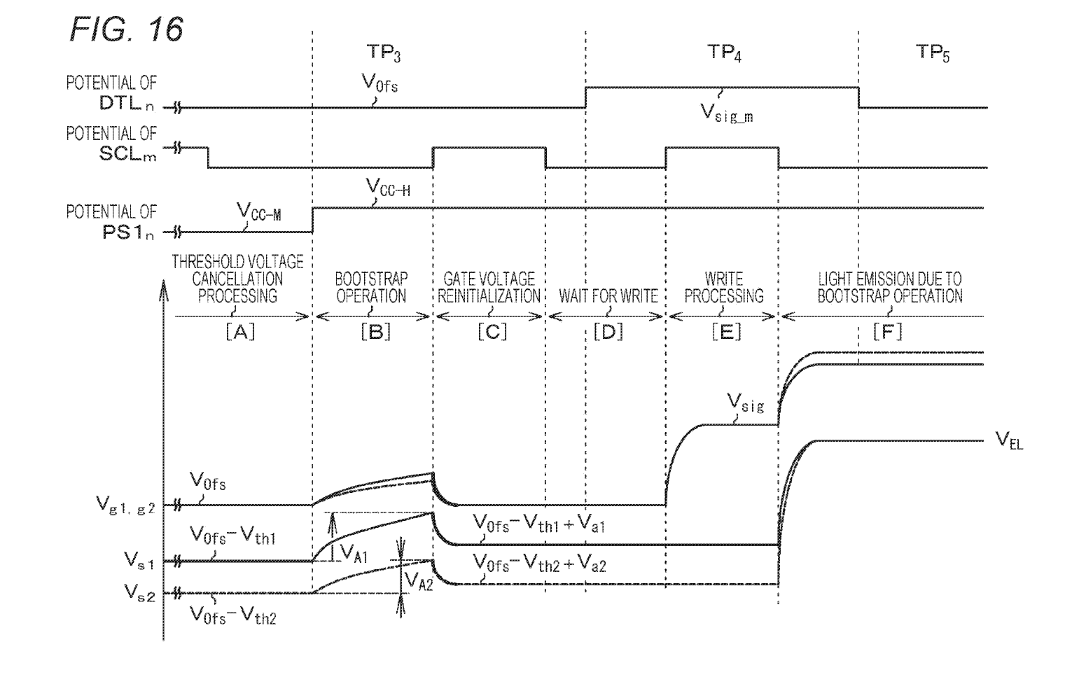

FIG. 16 is a schematic timing chart for explaining changes in the gate voltage and the source voltage of the drive transistor TR_{D}, in the display element including the drive transistor TR_{D} whose threshold voltage is Vₜₕ₁ and the display element including the drive transistor TR_{D} whose threshold voltage is Vₜₕ₂ (>Vₜₕ₁), in the display device according to the first embodiment. Note that, the waveform of the transistor whose threshold voltage is Vₜₕ₁ is indicated by a solid line, and the waveform of the transistor whose threshold voltage is Vₜₕ₂ is indicated by a broken line.

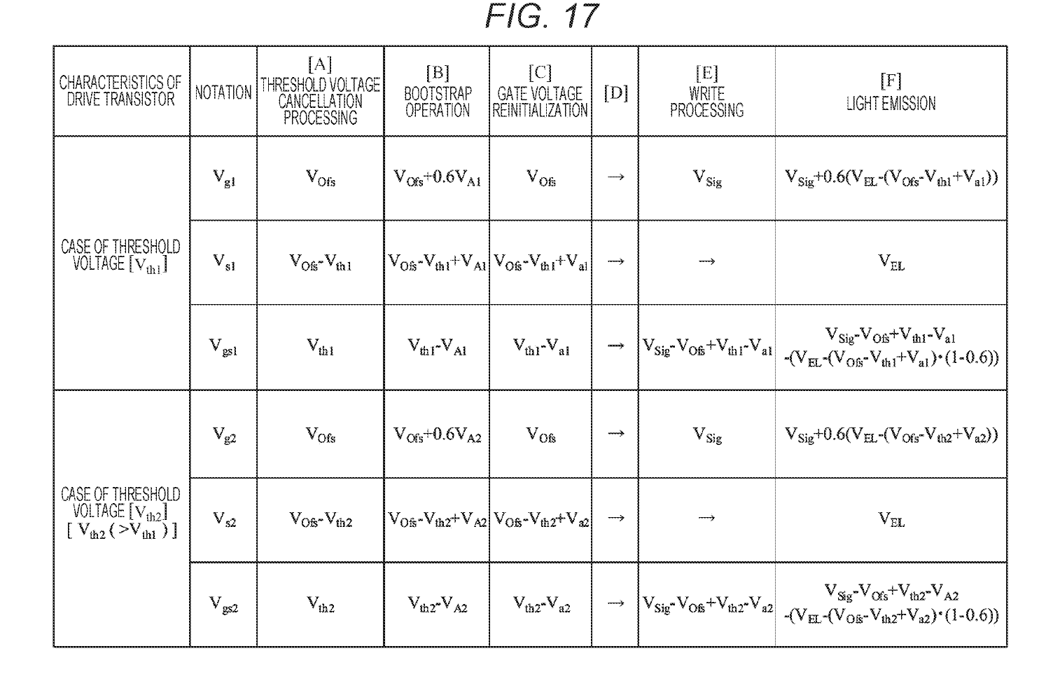

In addition, FIG. 17 is a table for explaining the voltage changes in FIG. 16. Note that, in this table, numerical values are described of an example in which the bootstrap gain G_{bst} is “0.6”.

In FIG. 16, reference signs V_{g1} and Vₛ₁ respectively indicate a gate voltage and a source voltage of the drive transistor TR_{D} whose threshold voltage is Vₜₕ₁. Similarly, reference signs V_{g2} and Vₛ₂ respectively indicate a gate voltage and a source voltage of the drive transistor TR_{D} whose threshold voltage is Vₜₕ₂. In addition, a reference sign V_{A1} indicates an amount of increase in the source voltage of the drive transistor TR_{D} whose threshold voltage is Vₜₕ₁ during the bootstrap operation in the [period-TP₃]. Similarly, a reference sign V_{A2} indicates an amount of increase in the source voltage of the drive transistor TR_{D} whose threshold voltage is Vₜₕ₂.

Qualitatively, even in transistors of the same type, a tendency is shown that a current flows more easily with a transistor whose threshold voltage is lower. In the example of FIG. 16, since Vₜₕ₁<Vₜₕ₂, there is a magnitude relationship such as V_{A1}>V_{A2}.

Then, if the voltage of the gate electrode is reinitialized in the [period-TP₃], the voltage of the source region also decreases to some extent in accordance with the potential change of the gate electrode.

As a result, the gate voltage Vₛ₁ and the gate voltage Vₛ₂ have values such as

Vₛ₁=V_{Ofs}−Vₜₕ₁+Vₐ₁

Vₛ₂=V_{Ofs}−Vₜₕ₂+Vₐ₂,

as indicated in a field of [C] in FIGS. 16 and 17.

As described above, there is a magnitude relationship such as V_{A1}>V_{A2} before reinitializing the voltage of the gate electrode. For this reason, Vₐ₁ and Vₐ₂ also show a magnitude relationship such as Vₐ₁>Vₐ₂. The reason will be described below.

The bootstrap gain G_{bst} described with reference to FIG. 9 is a value indicating the ratio of the gate voltage change to the source voltage change of the drive transistor TR_{D}, and is given as G_{bst}≡C_{S}/(C_{S}+Cₚ). Here, from a wiring line relationship of FIG. 9, a value Gᵢₙ is considered indicating the ratio of the source voltage change to the gate voltage change of the drive transistor TR_{D}. In this case, basically, Gᵢₙ is determined by a voltage dividing relationship in a circuit in which the capacitance C_{EL} of the light-emitting unit ELP and the capacitor C_{S} are connected in series. Specifically, the value is given as Gᵢₙ≡C_{S}/(C_{S}+C_{EL}).

Therefore, the voltage of V_{g1} in [B] of FIG. 16 is expressed as (V_{Ofs}+V_{A1}·G_{bst}), and decreases to V_{Ofs} in [C] of FIG. 16. An amount of decrease in Vₛ₁ due to decrease in V_{g1} is expressed as (V_{A1}·G_{bst}·Gᵢₙ). Similarly, the voltage of V_{g2} in [B] of FIG. 16 is expressed as (V_{Ofs}+V_{A2}·G_{bst}), and decreases to V_{Ofs} in [C] of FIG. 16. An amount of decrease in Vₛ₂ due to decrease in V_{g2} is expressed as (V_{A2}·G_{bst}·Gᵢₙ).

Then, Vₐ₁ and Vₐ₂ in [C] and [D] in FIG. 16 are expressed as

Vₐ₁=V_{A1}·(1−G_{bst}·Gᵢₙ)

Vₐ₂=V_{A2}·(1−G_{bst}·Gᵢₙ).

Since G_{bst} and Gᵢₙ are values determined from the voltage dividing relationship, (1−G_{bst}·Gᵢₙ) is a positive value. Therefore, if V_{A1}>V_{A2}, Vₐ₁>Vₐ₂.

Then, the gate voltage Vₛ₁ and the gate voltage Vₛ₂ after the write processing are values indicated in a field of [E] in FIG. 17, and the gate voltage Vₛ₁ and the gate voltage Vₛ₂ in a state where the bootstrap has occurred are values indicated in a field of [F] in FIG. 17.

From these values, in the first embodiment, in a case where the threshold voltages are Vₜₕ₁ and Vₜₕ₂, a difference in the amount of decrease in the gate-source voltage in the bootstrap operation is expressed as (1−0.6)·(Vₜₕ₂−Vₜₕ₁)−0.6×(Vₐ₁−Vₐ₂).

Therefore, as compared with a case of the reference example, the difference in the amount of decrease in the gate-source voltage in the bootstrap operation is canceled by 0.6×(Vₐ₁−Vₐ₂). As a result, luminance unevenness is reduced in which the amount of decrease in the gate-source voltage in the bootstrap operation is caused by variation in the threshold voltage Vₜₕ.

For length of a period during which the bootstrap operation is performed in the [period-TP₃] in FIG. 3, preferred length only needs to be set as appropriate in accordance with the design and specification of the display device, on the basis of actual measurements and the like.

The first embodiment has been specifically described above; however, the present disclosure is not limited to the embodiment described above, and various modifications can be made based on the technical idea of the present disclosure.

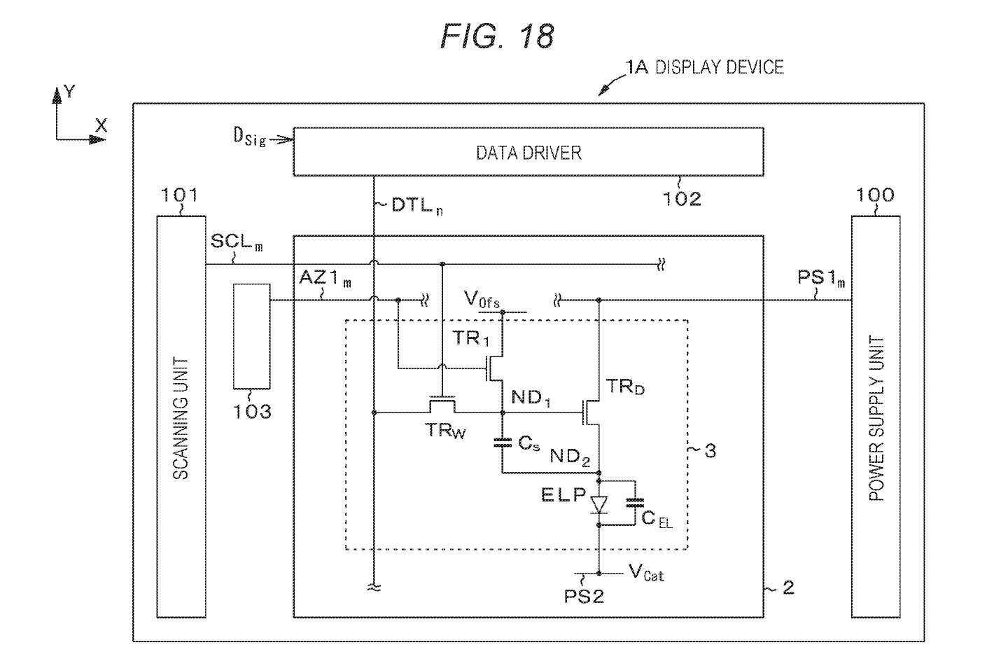

For example, as in a display device 1A illustrated in FIG. 18, the display element 3 may include a first node initialization transistor TR₁ connected to the first node ND₁. In the first node initialization transistor TR₁, the reference voltage V_{Ofs} is applied to one source/drain region, and the other source/drain region is connected to the first node ND₁. The first node initialization transistor TR₁ is set in a conductive state when a signal from a first node initialization circuit 103 is applied to its gate electrode, whereby the potential of the first node ND₁ can be initialized. Therefore, in this configuration, there is no need to supply the reference voltage V_{Ofs} from the data driver 102.

### SECOND EMBODIMENT

A second embodiment also relates to a display element and a method for driving the display element, and a display device and a method for driving the display device according to the present disclosure.

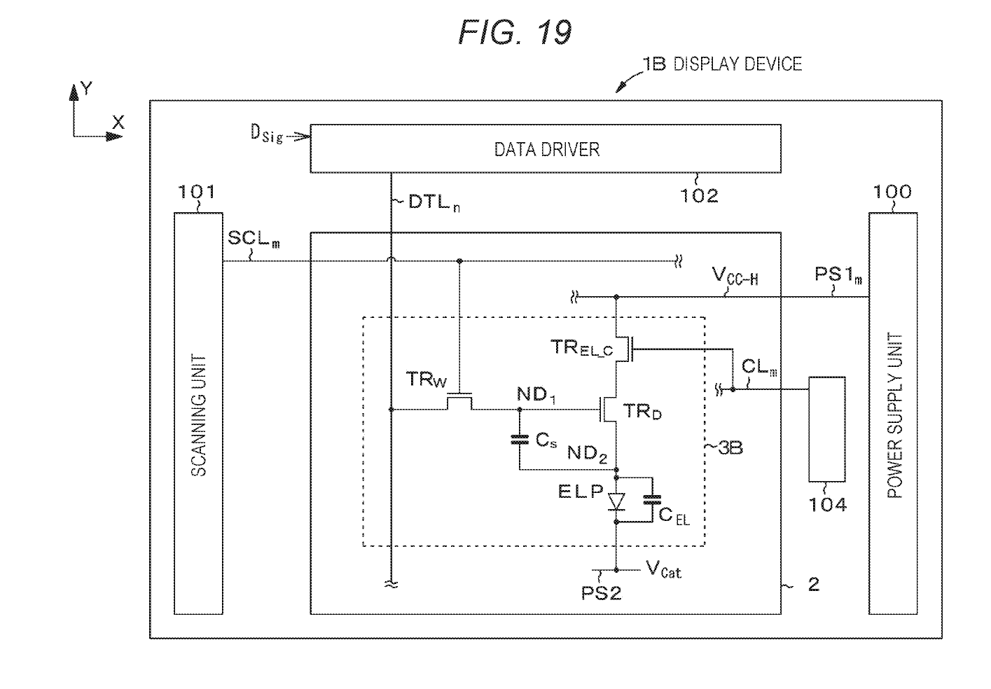

FIG. 19 is a conceptual diagram of the display device according to the second embodiment.

A display device 1B according to the second embodiment mainly differs from the display device 1 illustrated in FIG. 1 in that a display element 3 includes a light emission control transistor TR_{EL}_{_}_{C}, and a light emission control line CL and a light emission control unit 104 are included for controlling the light emission control transistor TR_{EL}_{_}_{C}. In the second embodiment, a power supply unit 100, a scanning unit 101, a data driver 102, and the light emission control unit 104 configures a drive unit that drives a display unit 2.

M emission control lines CL are provided similarly to the scanning lines SCL, and a gate electrode of the light emission control transistor TR_{EL}_{_}_{C} of the display element 3 in the m-th row is connected to the m-th light emission control line CLₘ. The light emission control unit 104 supplies a signal to the light emission control line CL. As a result, a conductive state/non-conductive state is controlled of the light emission control transistor TR_{EL}_{_}_{C} connected to the light emission control line CL. Note that, in FIG. 19, only the light emission control line CLₘ is illustrated.

Similarly to a drive transistor TR_{D} and a write transistor TR_{W}, the light emission control transistor TR_{EL}_{_}_{C} includes an re-channel TFT. Note that, for example, the write transistor TR_{W} can include a p-channel TFT.

The light emission control transistor TR_{EL}_{_}_{C} is disposed between one source/drain region of the drive transistor TR_{D} and a feeder line PS1. Therefore, a voltage is applied to the one source/drain region of the drive transistor TR_{D} via the light emission control transistor TR_{EL}_{_}_{C}.

The configuration of the display element 3 is similar to the configuration described in the first embodiment except that the light emission control transistor TR_{EL}_{_}_{C} is added. As in the first embodiment, a video signal voltage is applied to a gate electrode of the drive transistor TR_{D} via the write transistor TR_{W} in a conductive state.

Note that, a voltage supplied by the data driver 102 or the power supply unit 100 is different from the voltage in the first embodiment. The data driver 102 sequentially supplies a voltage V_{Ofs-H} exceeding a reference voltage V_{Ofs}, the reference voltage V_{Ofs}, and a video signal voltage V_{Sig}, to a data line DTL. More specifically, the voltage V_{Ofs-H} is supplied and then the reference voltage V_{Ofs} is supplied in the first half of a horizontal scanning period, and the video signal voltage V_{Sig} is supplied in the latter half. The power supply unit 100 supplies a second drive voltage V_{CC-H} to the feeder line PS1.

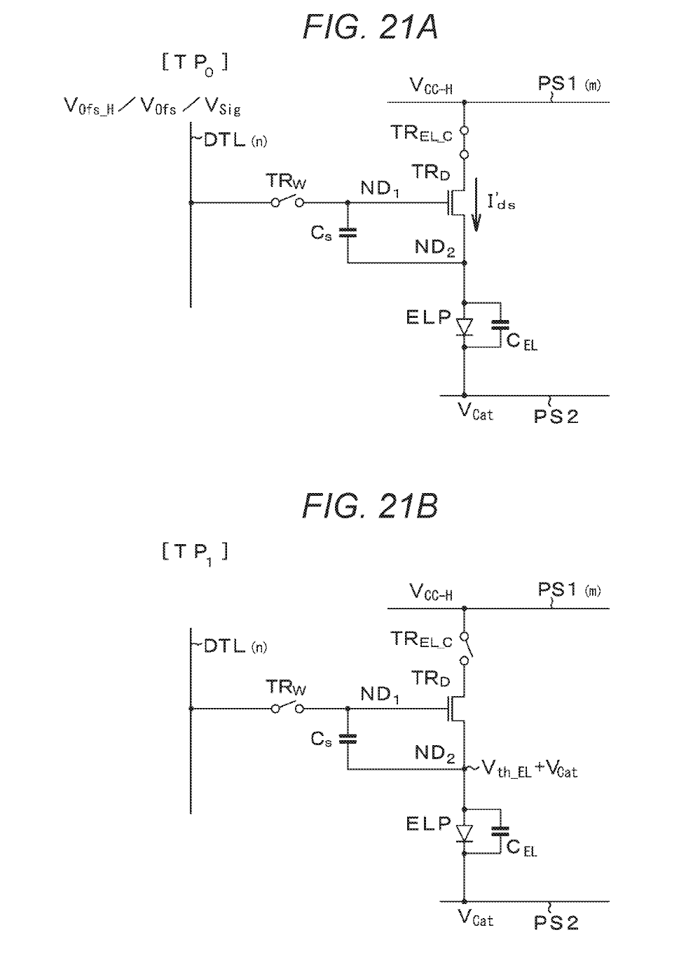

An outline of the display device 1B has been described above. Subsequently, an outline will be described of operation of the display device 1B. Detailed operation will be described in detail later with reference to FIGS. 21 to 26 as described later.

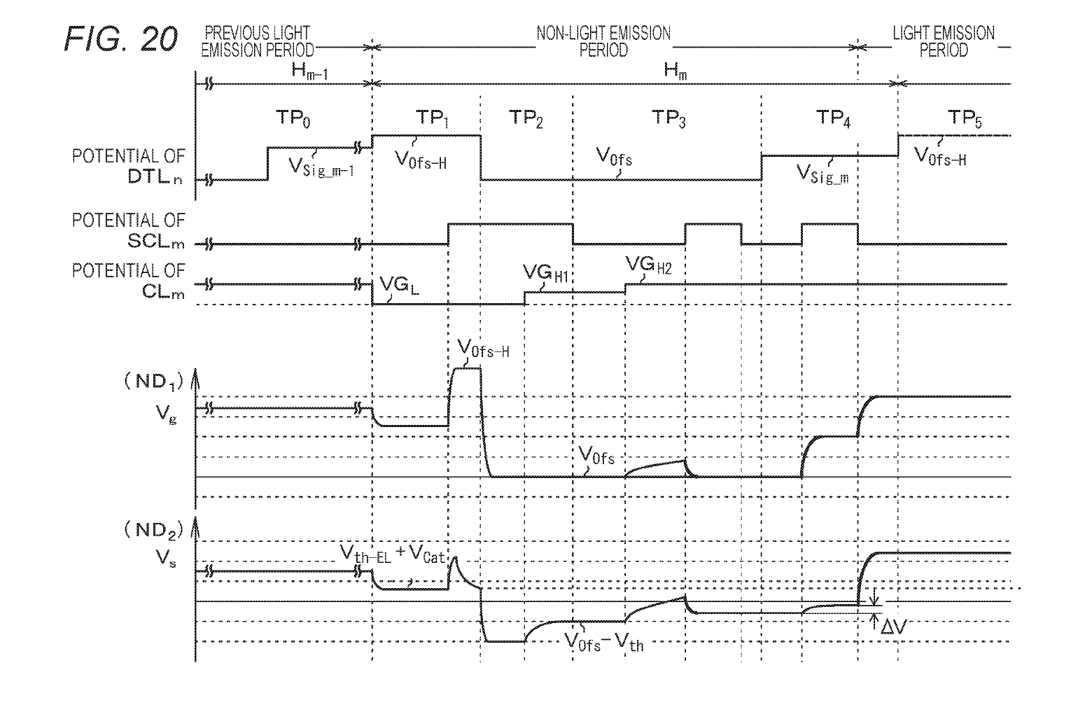

FIG. 20 is a schematic timing chart for explaining operation of the display device according to the second embodiment, more specifically, operation of an (n, m)-th display element of the display device.

As described above, in the present disclosure, in driving the display element 3 including the n-channel drive transistor TR_{D} in which the voltage is applied to the one source/drain region and the light-emitting unit ELP is connected to the other source/drain region, and the capacitor C_{S} connected between the gate electrode of the drive transistor TR_{D} and the other source/drain region,

performs threshold voltage cancellation processing that applies a drive voltage to the one source/drain region in a state where the reference voltage V_{Ofs} is applied to the gate electrode of the drive transistor TR_{D}, to bring a potential of the other source/drain region closer to a potential obtained by subtracting the threshold voltage Vₜₕ of the drive transistor TR_{D} from the reference voltage;

subsequently, sets the gate electrode of the drive transistor TR_{D} in the floating state, and changes a potential of the gate electrode in the floating state via parasitic capacitance and causing a current to flow via the drive transistor TR_{D} to increase a voltage between the other source/drain region and the gate electrode, and then applies the reference voltage V_{Ofs} to the gate electrode of the drive transistor TR_{D};

afterwards, performs write processing that applies the video signal voltage V_{Sig} to the gate electrode of the drive transistor TR_{D}; and

subsequently, sets the gate electrode of the drive transistor TR_{D} in the floating state to cause the light-emitting unit ELP to emit light.

Here, in the second embodiment,

the threshold voltage cancellation processing is performed to apply the drive voltage to the one source/drain region of the drive transistor TR_{D} via the light emission control transistor TR_{EL}_{_}_{C} set in the conductive state due to application of a first control voltage to its gate electrode, in a state where the reference voltage V_{Ofs} is applied to the gate electrode of the drive transistor TR_{D}, to bring the potential of the other source/drain region closer to the potential obtained by subtracting the threshold voltage Vₜₕ of the drive transistor TR_{D} from the reference voltage V_{Ofs}, and

subsequently, the gate electrode of the drive transistor TR_{D} is set in the floating state and the voltage applied to the gate of the light emission control transistor TR_{EL}_{_}_{C} is switched to a second control voltage exceeding the first control voltage, to change the potential of the gate electrode in the floating state via the parasitic capacitance and cause the current to flow via the drive transistor TR_{D}, to increase the voltage between the other source/drain region and the gate electrode, and then the reference voltage V_{Ofs} is applied to the gate electrode of the drive transistor TR_{D}.

In the following description, the values of the voltage or the potential are set as follows, but these are values for the purpose of illustration only and are not limited to these values.

VG_{L}: Voltage for setting light emission control transistor TR_{EL}_{_}_{C} in non-conductive state
. . . 0 volts

VG_{H1}: First control voltage for setting light emission control transistor TR_{EL}_{_}_{C} in conductive state
. . . 10 volts

VG_{H1}: Second control voltage for setting light emission control transistor TR_{EL}_{_}_{C} in conductive state
. . . 15 Volts

V_{Ofs-H}: Voltage exceeding reference voltage V_{Ofs}
. . . 30 Volts

[Period-TP₀] (See FIGS. 20 and 21 A)

A [period-TP₀] illustrated in FIG. 20 is, for example, of operation in a previous display frame, and is a period in which an (n, m)-th display element 3 is in a light emitting state. A drain current flows through the light-emitting unit ELP in the display element 3 configuring the (n, m)-th pixel via the drive transistor TR_{D}. The write transistor TR_{W} is in a non-conductive state, and the light emission control transistor TR_{EL}_{_}_{C} and the drive transistor TR_{D} are each in the conductive state.

[Period-TP₁] to [Period-TP₂] (See FIGS. 20, 21B, 22A, 22B and 23A)

After this [period-TP₁] is, for example, of operation in a current display frame. In the [period-TP₁] to [period-TP₂], the light emission control transistor TR_{EL}_{_}_{C} is set in the non-conductive state and a voltage exceeding the reference voltage V_{Ofs} is applied to the gate electrode of the drive transistor TR_{D}, and subsequently the reference voltage V_{Ofs} is applied, to initialize the potential of the other source/drain region of the drive transistor TR_{D}, and after that, the threshold voltage cancellation processing is performed. The voltage V_{Ofs-H} exceeding the reference voltage V_{Ofs} and the reference voltage V_{Ofs} are applied to the gate electrode of the drive transistor TR_{D} via the write transistor TR_{W} set in the conductive state.

Specifically, in the beginning period of the [period-TP₁], a voltage VG_{L} is supplied to the light emission control line CLₘ, and the light emission control transistor TR_{EL}_{_}_{C} is set in the non-conductive state. Since the drive transistor TR_{D} and a feeder line PS1ₘ are electrically disconnected from each other, the light-emitting unit ELP is turned off. As a result, the potential of the other source/drain region of the drive transistor TR_{D} (that is, the potential of the second node ND₂) decreases to a value such as (V_{th-EL}+V_{Cat}) (see FIG. 21B). Since the write transistor TR_{W} is in the non-conductive state and the first node ND₁ and the second node ND₂ are connected together via the capacitor C_{S}, the potential of the first node ND₁ also decreases with potential decrease in the second node ND₂.

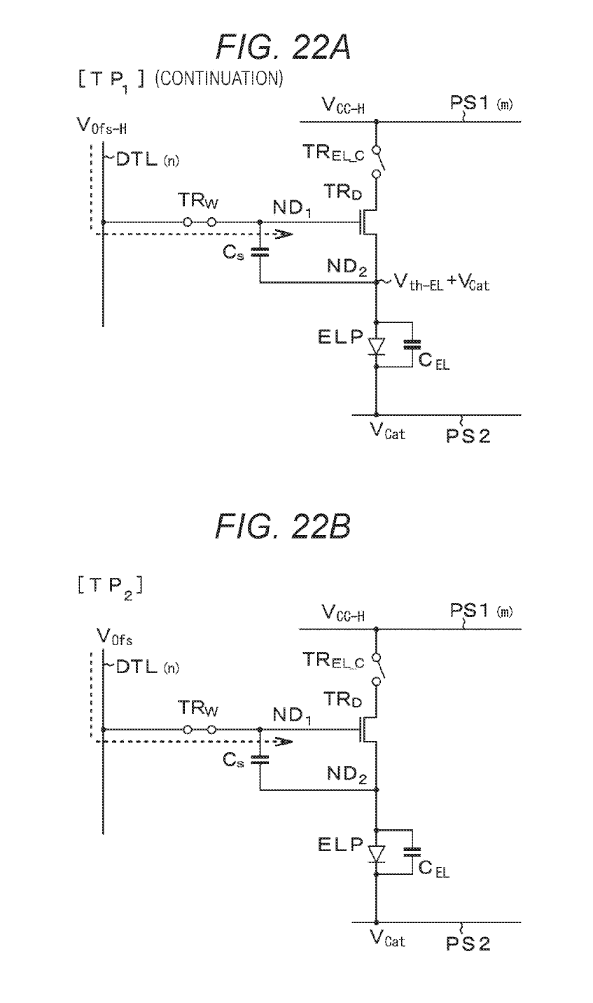

Note that, from the start of the [period-TP₁], the voltage V_{Ofs-H} exceeding the reference voltage V_{Ofs} is supplied to a data line DTLₙ. The scanning line SCL is set to a high level in the middle of the [period-TP₁], to set the write transistor TR_{W} in the conductive state. As a result, the potential of the first node ND₁ increases to V_{Ofs-H}. Since the first node ND₁ and the second node ND₂ are connected together via the capacitor C_{S}, the second node ND₂ also increases. As a result, a potential difference between both ends of the light-emitting unit ELP exceeds the threshold voltage V_{th-EL}, so that the potential light-emitting unit ELP is in a conductive state, but the potential of the source region of the drive transistor TR_{D} immediately decreases to (V_{th-EL}+V_{Cat}) again (see FIG. 22A). Note that, in this process, although the light-emitting unit ELP can emit light, the light emission is momentary and is not a problem practically. Meanwhile, the gate electrode of the drive transistor TR_{D} holds the voltage V_{Ofs-H}.

Then, in the [period-TP₂], the voltage of the data line DTLₙ is switched to the reference voltage V_{Ofs}. As a result, the potential of the first node ND₁ is V_{Ofs} (see FIG. 22B). Then, with potential decrease in the first node ND₁, the potential of the second node ND₂ also decreases. That is, charges based on a change (V_{Ofs}−V_{Ofs-H}) in the potential of the gate electrode of the drive transistor TR_{D} are distributed to the capacitor C_{S}, the parasitic capacitance C_{EL} of the light-emitting unit ELP, and parasitic capacitance between the source region and the gate electrode of the drive transistor TR_{D}. Note that, as a prerequisite for threshold correction operation, the potential of the second node ND₂ needs to be lower than (V_{Ofs}−Vₜₕ). Values of the voltage V_{Ofs-H} and the like are set to satisfy this condition. That is, with the above processing, the potential difference between the source region and the gate electrode of the drive transistor TR_{D} is equal to or greater than Vₜₕ, and the drive transistor TR_{D} is set in the conductive state.

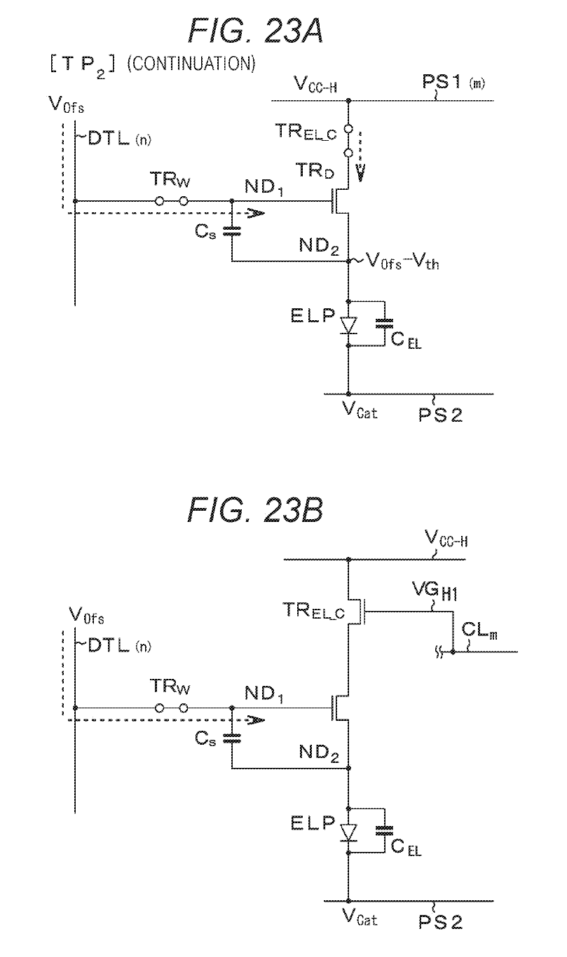

Next, the threshold voltage cancellation processing is performed to apply the drive voltage to the one source/drain region of the drive transistor TR_{D} via the light emission control transistor TR_{EL}_{_}_{C} set in the conductive state due to application of a first control voltage VG_{H1} to the gate electrode, in a state where the reference voltage V_{Ofs} is applied to the gate electrode of the drive transistor TR_{D}, to bring the potential of the other source/drain region closer to the potential obtained by subtracting the threshold voltage Vₜₕ of the drive transistor TR_{D} from the reference voltage V_{Ofs} (see FIG. 23A).

Specifically, the first control voltage VG_{H1} is supplied to the light emission control line CLₘ in a state where the conductive state of the write transistor TR_{W} is kept (see FIG. 23B). Since the gate-source voltage of the drive transistor TR_{D} exceeds the threshold voltage Vₜₕ, the current flows through the drive transistor TR_{D} and the potential of the other source/drain region increases. As a result, the potential of the second node ND₂ is brought to be closer to the potential obtained by subtracting the threshold voltage Vₜₕ of the drive transistor TR_{D} from the reference voltage V_{Ofs}. If the potential of the second node ND₂ reaches (V_{Ofs}−Vₜₕ), the drive transistor TR_{D} is in a non-conductive state.

[Period-TP₃] (See FIGS. 20, 24A, 24B, 25A, 25B, and 26)

In this [period-TP₃], the gate electrode of the drive transistor TR_{D} is set in the floating state, and the potential of the gate electrode in the floating state is changed via the parasitic capacitance and the current is caused to flow via the drive transistor TR_{D}, to increase the voltage between the other source/drain region and the gate electrode, and then the reference voltage V_{Ofs} is applied to the gate electrode of the drive transistor TR_{D}.

Specifically, the gate electrode of the drive transistor TR_{D} is set in the floating state and the voltage applied to the gate of the light emission control transistor TR_{EL}_{_}_{C} is switched to a second control voltage VG_{H2} exceeding the first control voltage VG_{H1}, to change the potential of the gate electrode in the floating state via the parasitic capacitance and cause the current to flow via the drive transistor TR_{D}, to increase the voltage between the other source/drain region and the gate electrode, and then the reference voltage V_{Ofs} is applied to the gate electrode of the drive transistor TR_{D}.

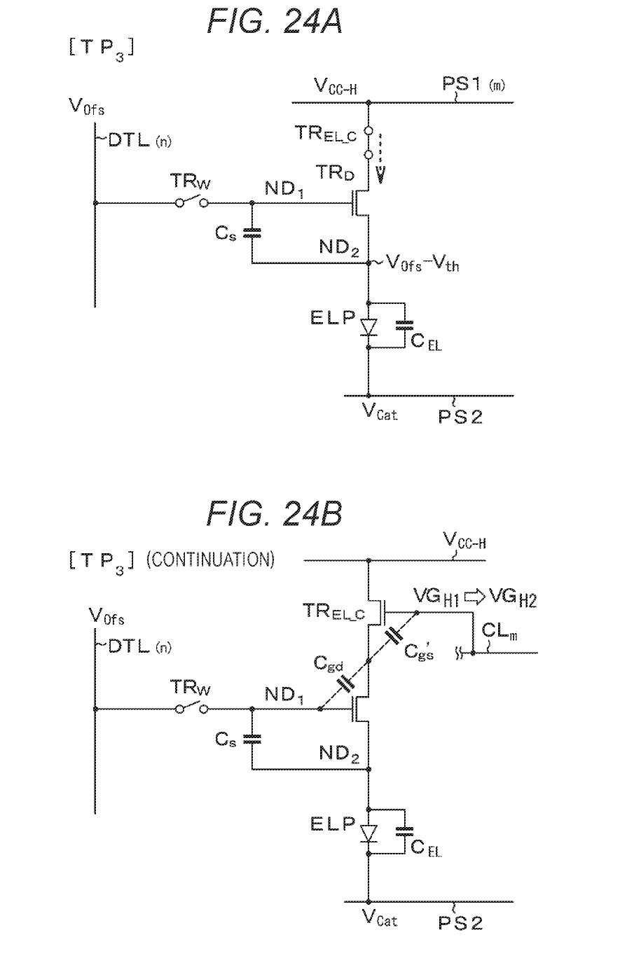

In the beginning period of the [period-TP₃], the scanning line SCLₘ is set to a low level, and the write transistor TR_{W} is set in the non-conductive state. As a result, the first node ND₁ is in the floating state. If the drive transistor TR_{D} has reached the non-conductive state in the [period-TP₂], the potentials of the first node ND₁ and the second node ND₂ do not substantially change (see FIG. 24A).

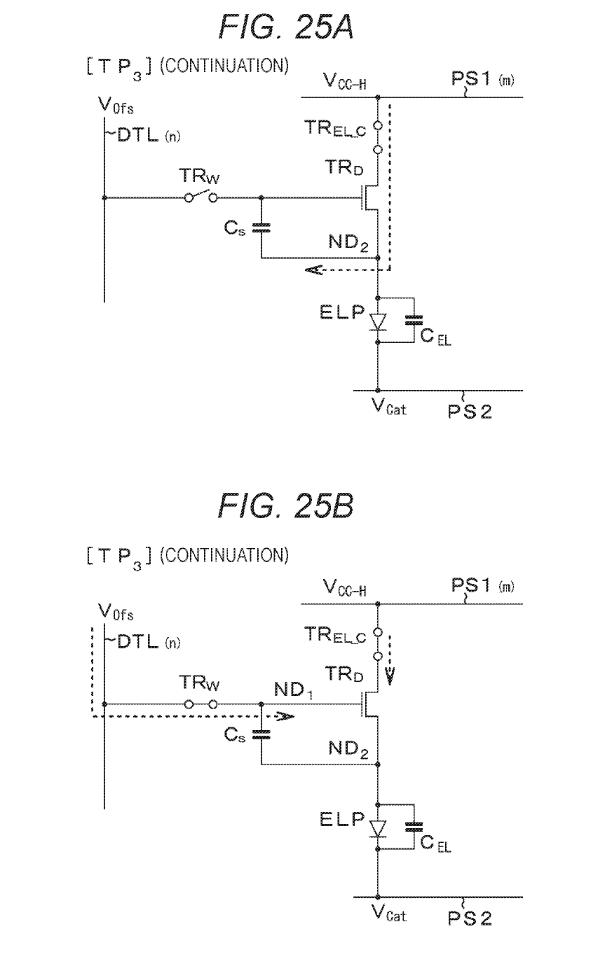

In the second embodiment, the voltage of the light emission control line CLₘ is switched from the first control voltage VG_{H1} to the second control voltage VG_{H2} in the middle of the [period-TP₃] (see FIG. 24B). Here, since there is parasitic capacitance C_{gd} between the one source/drain region and the gate electrode of the drive transistor TR_{D} and also there is parasitic capacitance (represented by a reference sign C_{gs}′) between the source region and the gate electrode of the light emission control transistor TR_{EL}_{_}_{C}, the potential of the gate electrode of the drive transistor TR_{D} also increases due to capacitive coupling. As a result, since the gate-source voltage of the drive transistor TR_{D} exceeds the threshold voltage Vₜₕ, the current flows via the drive transistor TR_{D}, and the potential of the second node ND₂ increases. Then, the voltage of the gate electrode of the drive transistor TR_{D}, in other words, the voltage of the first node ND₁ also increases due to bootstrap operation (see FIG. 25A).

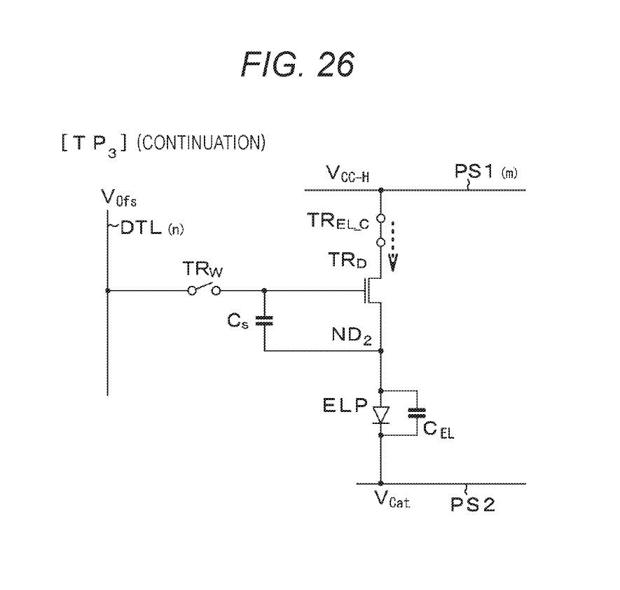

After that, the reference voltage V_{Ofs} is applied to the gate electrode of the drive transistor TR_{D} from the data line DTLₙ via the write transistor TR_{W} set in the conductive state on the basis of the scanning signal from the scanning line SCL. The potential of the other source/drain region of the drive transistor TR_{D} decreases and is initialized to V_{CC-L} again. The potential of the second node ND₂ also decreases. As a result, the drive transistor TR_{D} is set in the non-conductive state (see FIG. 25B). After that, the write transistor TR_{W} is set in the non-conductive, but the drive transistor TR_{D} keeps the non-conductive state (see FIG. 26).

Since the operation after the [period-TP₄] is similar to the operation described in the first embodiment, the description will be omitted.

Voltage changes of the gate electrode and the source region of the drive transistor TR_{D} in the [period-TP₃] of the second embodiment is similar to the voltage changes in the [period-TP₃] of the first embodiment. Therefore, similarly to the description of the first embodiment, luminance unevenness is reduced in which the amount of decrease in the gate-source voltage in the bootstrap operation is caused by variation in the threshold voltage Vₜₕ.

The second embodiment has been specifically described above; however, the present disclosure is not limited to the embodiment described above, and various modifications can be made based on the technical idea of the present disclosure.

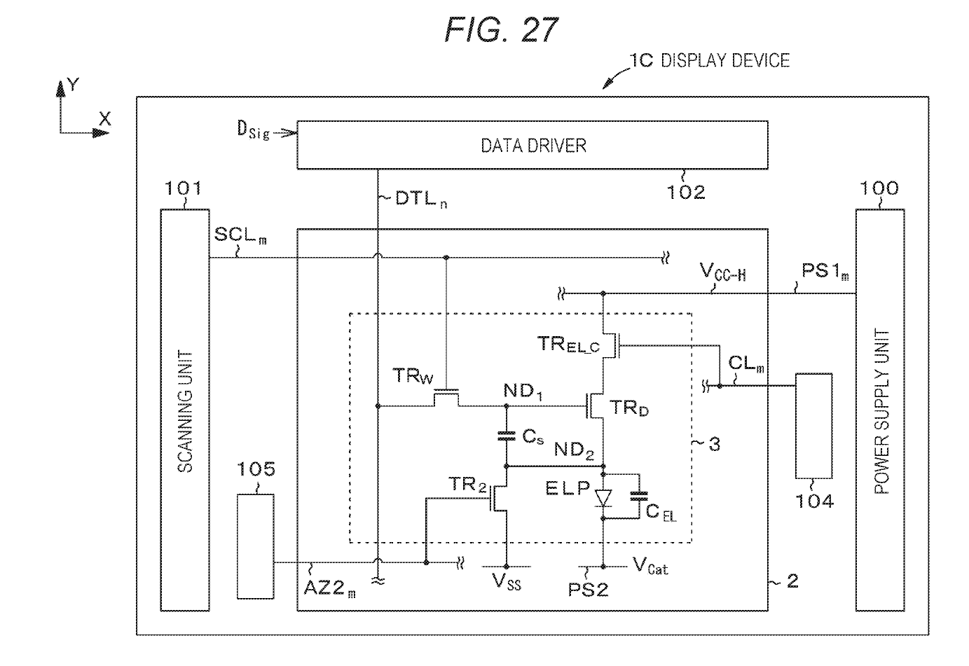

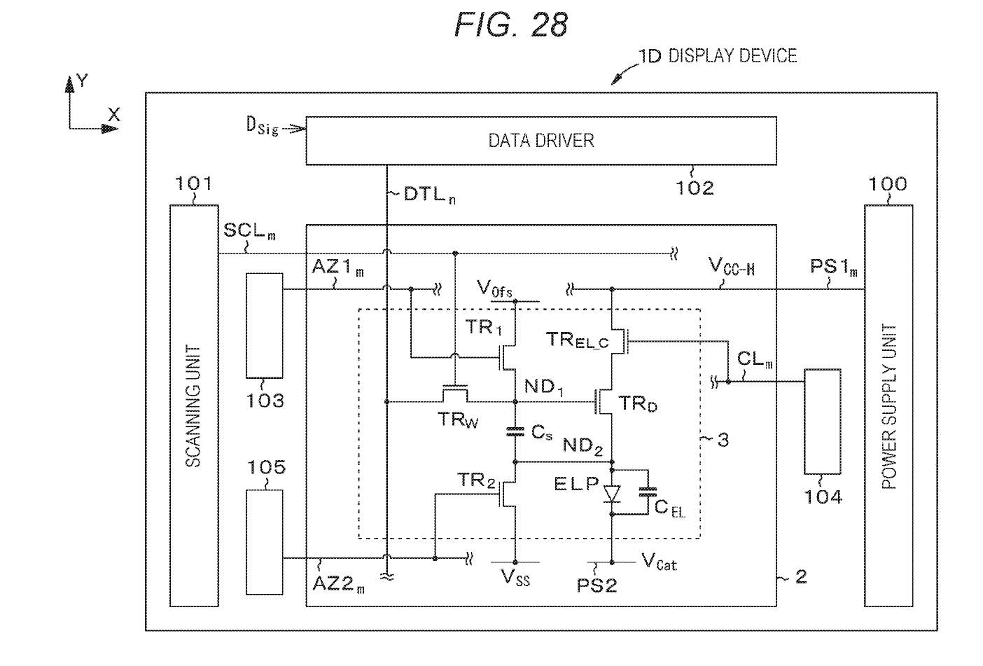

For example, as in a display device 1C illustrated in FIG. 27, the display element 3 may include a second node initialization transistor TR₂ connected to the second node ND₂. In the second node initialization transistor TR₂, an initialization voltage V_{SS} is applied to one source/drain region, and the other source/drain region is connected to the second node ND₂. A signal from the second node initialization circuit 105 is applied to a gate electrode of the second node initialization transistor TR₂, whereby its conductive state/non-conductive state is controlled, so that the potential of the second node ND₂ can be initialized. Therefore, there is no need for the data driver 102 to supply the voltage V_{Ofs-H} or the voltage V_{Ofs}. In addition, as in a display device 1D illustrated in FIG. 28, the display element 3 may include a first node initialization transistor TR₁ connected to the first node ND₁, and the second node initialization transistor TR₂ connected to the second node ND₂.

The embodiments have been specifically described above; however, the present disclosure is not limited to the embodiments described above, and various modifications can be made based on the technical idea of the present disclosure. For example, numerical values, structures, substrates, raw materials, processes, and the like mentioned in the embodiments described above are merely examples, and numerical values, structures, substrates, raw materials, processes, and the like different from the above may be used as needed.

The display device of the present disclosure described above can be used as a display unit (display device) of an electronic device in all fields, the display unit displaying a video signal input to the electronic device or a video signal generated in the electronic device as an image or a video. For example, the display device can be used as a display unit of a television set, a digital still camera, a laptop personal computer, a mobile terminal device such as a mobile phone, a video camera, a head mounted display, and the like.

The display device of the present disclosure also includes a module shape display device having a sealed configuration. An example is a display module in which a facing unit such as transparent glass is attached to a pixel array unit. Note that, the display module may be provided with a circuit unit for inputting/outputting a signal and the like to the pixel array unit from the outside, a flexible printed circuit (FPC), and the like. As a specific example of the electronic device using the display device of the present disclosure, a digital still camera and a head mounted display will be exemplified below. However, the specific example exemplified here is merely an example, and the present invention is not limited to the example.

### SPECIFIC EXAMPLE 1

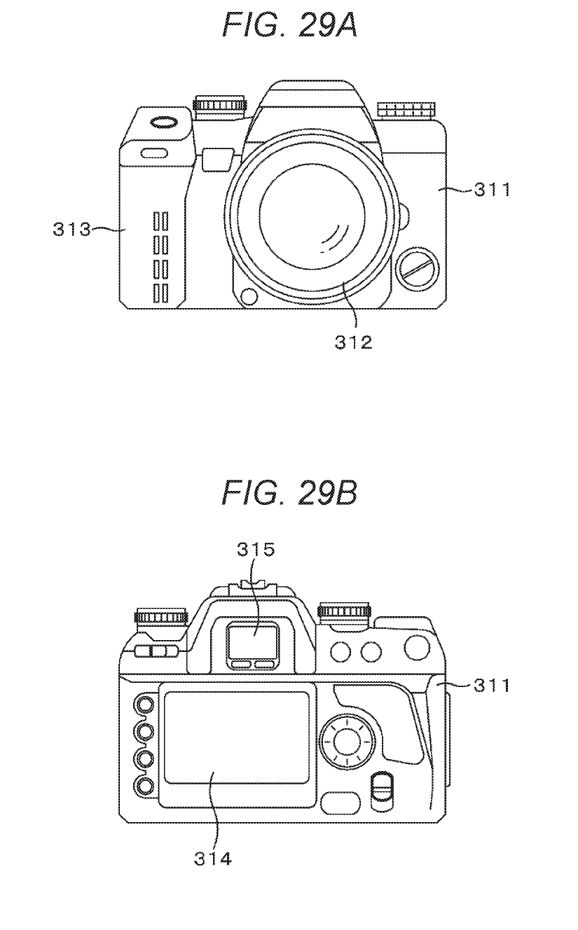

FIG. 29 is an external view of a lens interchangeable single lens reflex type digital still camera, and FIG. 29A illustrates a front view of the camera and FIG. 29B illustrates a rear view of the camera. The lens interchangeable single lens reflex type digital still camera includes an interchangeable photographing lens unit (interchangeable lens) 312 on the front right side of the camera body part (camera body) 311, and includes a grip part 313 to be held by a photographer on the front left side, for example.

Furthermore, a monitor 314 is provided substantially at the center of the rear surface of the camera body part 311. A viewfinder (eyepiece window) 315 is provided on the top of the monitor 314. The photographer can look in the viewfinder 315, to visually recognize an optical image of a subject guided from the photographing lens unit 312 and determine composition.

In the lens interchangeable single lens reflex type digital still camera with the above configuration, the display device of the present disclosure can be used as the viewfinder 315. That is, the lens interchangeable single lens reflex type digital still camera according to this example is manufactured by using the display device of the present disclosure as the viewfinder 315.

### SPECIFIC EXAMPLE 2

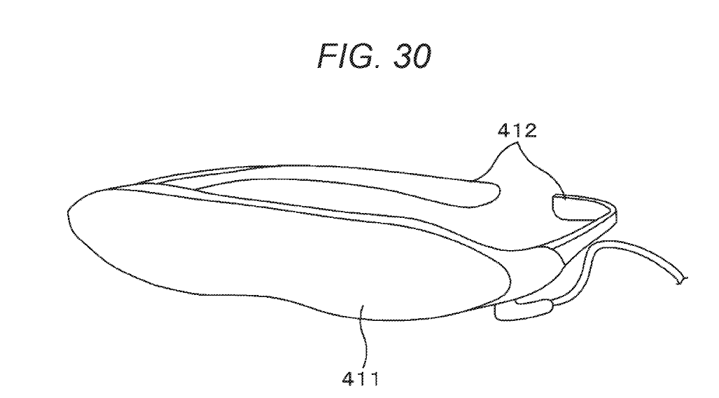

FIG. 30 is an external view of a head mounted display. The head mounted display includes, for example, an ear hooking part 412 for attaching to the head of a user on both sides of an eyeglasses-shaped display unit 411. In this head mounted display, the display device of the present disclosure can be used as the display unit 411. That is, the head mounted display according to this example is manufactured by using the display device of the present disclosure as the display unit 411.

### SPECIFIC EXAMPLE 3

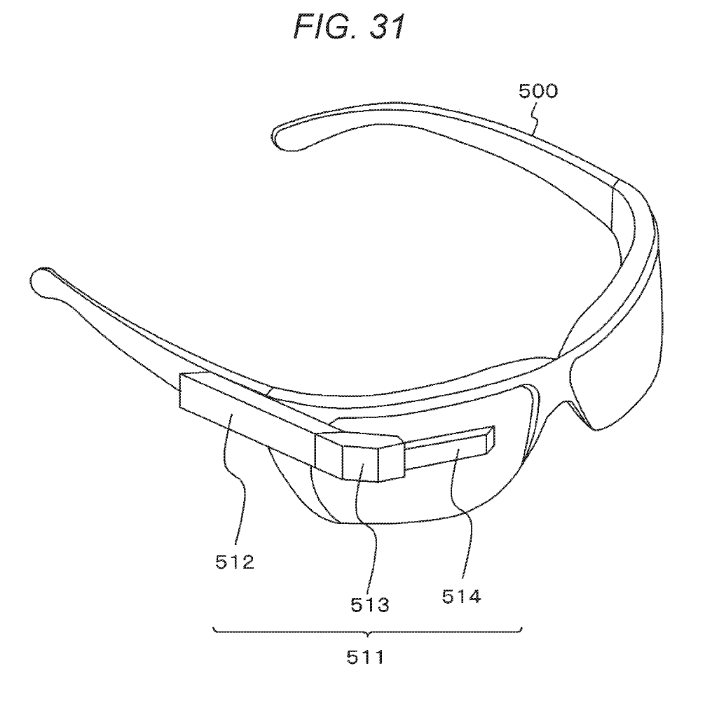

FIG. 31 is an external view of a see-through head mounted display. A see-through head mounted display 511 includes a body part 512, an arm 513, and a lens barrel 514.

The body part 512 is connected to the arm 513 and eyeglasses 500. Specifically, an end portion in a long side direction of the body part 512 is coupled to the arm 513, and one side surface of the body part 512 is connected to the eyeglasses 500 via a connection member. Note that, the body part 512 may be directly mounted to the head of a human body.

The body part 512 incorporates a control board for controlling operation of the see-through head mounted display 511 and a display unit. The arm 513 connects the body part 512 and the lens barrel 514 together, and supports the lens barrel 514. Specifically, the arm 513 is coupled to each of the end portion of the body part 512 and an end portion of the lens barrel 514, and fixes the lens barrel 514. In addition, the arm 513 incorporates a signal line for communicating data related to an image provided from the body part 512 to the lens barrel 514.

The lens barrel 514 projects image light provided from the body part 512 via the arm 513 toward eyes of a user wearing the see-through head mounted display 511 through an eyepiece. In the see-through head mounted display 511, the display device of the present disclosure can be used for the display unit of the body part 512.

Note that, the technology of the present disclosure can also adopt the following configuration.

[1]

A method for driving a display element including:

in driving a display element including an n-channel drive transistor in which a voltage is applied to one source/drain region and a light-emitting unit is connected to another source/drain region, and a capacitor connected between a gate electrode of the drive transistor and the other source/drain region,

performing threshold voltage cancellation processing that applies a drive voltage to the one source/drain region in a state where a reference voltage is applied to the gate electrode of the drive transistor, to bring a potential of the other source/drain region closer to a potential obtained by subtracting a threshold voltage of the drive transistor from the reference voltage;

subsequently, setting the gate electrode of the drive transistor in a floating state, and changing a potential of the gate electrode in the floating state via parasitic capacitance and causing a current to flow via the drive transistor to increase a voltage between the other source/drain region and the gate electrode, and then applying the reference voltage to the gate electrode of the drive transistor;

afterwards, performing write processing that applies a video signal voltage to the gate electrode of the drive transistor; and

subsequently, setting the gate electrode of the drive transistor in the floating state to cause the light-emitting unit to emit light.

[2]

The method for driving a display element according to [1], in which

the threshold voltage cancellation processing is performed to apply a first drive voltage to the one source/drain region in the state where the reference voltage is applied to the gate electrode of the drive transistor, to bring the potential of the other source/drain region closer to the potential obtained by subtracting the threshold voltage of the drive transistor from the reference voltage, and

subsequently, the gate electrode of the drive transistor is set in the floating state and the voltage of the one source/drain region of the drive transistor is switched to a second drive voltage exceeding the first drive voltage, to change the potential of the gate electrode in the floating state via the parasitic capacitance and cause the current to flow via the drive transistor, to increase the voltage between the other source/drain region and the gate electrode, and then the reference voltage is applied to the gate electrode of the drive transistor.

[3]

The method for driving a display element according to [2], in which

before the threshold voltage cancellation processing, the potential of the other source/drain region is initialized by switching the voltage applied to the one source/drain region of the drive transistor from the second drive voltage to an initialization voltage.

[4]

The method for driving a display element according to [3], in which

the initialization voltage is a voltage set to a predetermined value lower than a voltage obtained by subtracting the threshold voltage of the drive transistor from the reference voltage.

[5]

The method for driving a display element according to any of [2] to [4], in which

the display element further includes a write transistor connected to the gate electrode of the drive transistor, and

the video signal voltage is applied to the gate electrode of the drive transistor via the write transistor set in a conductive state.

[6]

The method for driving a display element according to [5], in which

the reference voltage is applied to the gate electrode of the drive transistor via the write transistor set in the conductive state.

[7]

The method for driving a display element according to [1], in which

a voltage is applied to the one source/drain region of the drive transistor via a light emission control transistor,

the threshold voltage cancellation processing is performed to apply the drive voltage to the one source/drain region of the drive transistor via the light emission control transistor set in a conductive state due to application of a first control voltage to its gate electrode, in a state where the reference voltage is applied to the gate electrode of the drive transistor, to bring the potential of the other source/drain region closer to the potential obtained by subtracting the threshold voltage of the drive transistor from the reference voltage, and

subsequently, the gate electrode of the drive transistor is set in the floating state and the voltage applied to the gate of the light emission control transistor is switched to a second control voltage exceeding the first control voltage, to change the potential of the gate electrode in the floating state via the parasitic capacitance and cause the current to flow via the drive transistor, to increase the voltage between the other source/drain region and the gate electrode, and then the reference voltage is applied to the gate electrode of the drive transistor.

[8]

The method for driving a display element according to [7], in which

the display element further includes a write transistor connected to the gate electrode of the drive transistor, and

the video signal voltage is applied to the gate electrode of the drive transistor via the write transistor set in a conductive state.

[9]

The method for driving a display element according to [8], in which

before the threshold voltage cancellation processing,

the light emission control transistor is set in the non-conductive state and a voltage exceeding the reference voltage is applied to the gate electrode of the drive transistor and subsequently the reference voltage is applied, to initialize the potential of the other source/drain region of the drive transistor.

[10]

The method for driving a display element according to [8], in which

the voltage exceeding the reference voltage and the reference voltage are applied to the gate electrode of the drive transistor via the write transistor set in the conductive state.

[11]

The method for driving a display element according to any of [1] to [10], in which

the potential of the other source/drain region of the drive transistor changes due to the current flowing through the drive transistor, in the write processing.

[12]

The method for driving a display element according to any of [1] to [11], in which

the light-emitting unit includes a current drive type electro-optical element whose light emission luminance varies in accordance with a value of a current flowing.

[13]

The method for driving a display element according to [12], in which

the light-emitting unit is an organic electroluminescence element.

[14]

A display device including:

a display unit in which a display element is disposed, the display element including an n-channel drive transistor in which a voltage is applied to one source/drain region and a light-emitting unit is connected to another source/drain region, and a capacitor connected between a gate electrode of the drive transistor and the other source/drain region; and a drive unit that drives the display unit, in which

the drive unit

performs threshold voltage cancellation processing that applies a drive voltage to the one source/drain region in a state where a reference voltage is applied to the gate electrode of the drive transistor, to bring a potential of the other source/drain region closer to a potential obtained by subtracting a threshold voltage of the drive transistor from the reference voltage,

subsequently, sets the gate electrode of the drive transistor in a floating state, and changes a potential of the gate electrode in the floating state via the parasitic capacitance and causes a current to flow via the drive transistor to increase a voltage between the other source/drain region and the gate electrode, and then applies the reference voltage to the gate electrode of the drive transistor,

afterwards, performs write processing that applies a video signal voltage to the gate electrode of the drive transistor, and

subsequently, sets the gate electrode of the drive transistor in the floating state to cause the light-emitting unit to emit light.

[15]

The display device according to [14], in which

the threshold voltage cancellation processing is performed to apply a first drive voltage to the one source/drain region in the state where the reference voltage is applied to the gate electrode of the drive transistor, to bring the potential of the other source/drain region closer to the potential obtained by subtracting the threshold voltage of the drive transistor from the reference voltage, and

subsequently, the gate electrode of the drive transistor is set in the floating state and the voltage of the one source/drain region of the drive transistor is switched to a second drive voltage exceeding the first drive voltage, to change the potential of the gate electrode in the floating state via the parasitic capacitance and cause the current to flow via the drive transistor, to increase the voltage between the other source/drain region and the gate electrode, and then the reference voltage is applied to the gate electrode of the drive transistor.

[16]

The display device according to [15], in which

before the threshold voltage cancellation processing, the potential of the other source/drain region is initialized by switching the voltage applied to the one source/drain region of the drive transistor from the second drive voltage to an initialization voltage.

[17]

The display device according to [16], in which

the initialization voltage is a voltage set to a predetermined value lower than a voltage obtained by subtracting the threshold voltage of the drive transistor from the reference voltage.

[18]

The display device according to any of [15] to [17], in which

the display element further includes a write transistor connected to the gate electrode of the drive transistor, and

the video signal voltage is applied to the gate electrode of the drive transistor via the write transistor set in a conductive state.

[19]

The display device according to [18], in which

the reference voltage is applied to the gate electrode of the drive transistor via the write transistor set in the conductive state.

[20]

The display device according to [14], in which

a voltage is applied to the one source/drain region of the drive transistor via a light emission control transistor,

the threshold voltage cancellation processing is performed to apply the drive voltage to the one source/drain region of the drive transistor via the light emission control transistor set in a conductive state due to application of a first control voltage to its gate electrode, in a state where the reference voltage is applied to the gate electrode of the drive transistor, to bring the potential of the other source/drain region closer to the potential obtained by subtracting the threshold voltage of the drive transistor from the reference voltage, and

subsequently, the gate electrode of the drive transistor is set in the floating state and the voltage applied to the gate of the light emission control transistor is switched to a second control voltage exceeding the first control voltage, to change the potential of the gate electrode in the floating state via the parasitic capacitance and cause the current to flow via the drive transistor, to increase the voltage between the other source/drain region and the gate electrode, and then the reference voltage is applied to the gate electrode of the drive transistor.

[21]

The display device according to [20], in which

the display element further includes a write transistor connected to the gate electrode of the drive transistor, and

the video signal voltage is applied to the gate electrode of the drive transistor via the write transistor set in a conductive state.

[22]

The display device according to [21], in which

before the threshold voltage cancellation processing,

the light emission control transistor is set in the non-conductive state and a voltage exceeding the reference voltage is applied to the gate electrode of the drive transistor and subsequently the reference voltage is applied, to initialize the potential of the other source/drain region of the drive transistor.

[23]

The display device according to [21], in which

the voltage exceeding the reference voltage and the reference voltage are applied to the gate electrode of the drive transistor via the write transistor set in the conductive state.

[24]

The display device according to any of [14] to [23], in which

the potential of the other source/drain region of the drive transistor changes due to the current flowing through the drive transistor, in the write processing.

[25]

The display device according to any of [14] to [24], in which

the light-emitting unit includes a current drive type electro-optical element whose light emission luminance varies in accordance with a value of a current flowing.

[26]

The display device according to [25], in which

the light-emitting unit is an organic electroluminescence element.

[27]

An electronic device including a display device, in which

the display device includes:

a display unit in which a display element is disposed, the display element including an n-channel drive transistor in which a voltage is applied to one source/drain region and a light-emitting unit is connected to another source/drain region, and a capacitor connected between a gate electrode of the drive transistor and the other source/drain region; and a drive unit that drives the display unit, in which

the drive unit

performs threshold voltage cancellation processing that applies a drive voltage to the one source/drain region in a state where a reference voltage is applied to the gate electrode of the drive transistor, to bring a potential of the other source/drain region closer to a potential obtained by subtracting a threshold voltage of the drive transistor from the reference voltage,

subsequently, sets the gate electrode of the drive transistor in a floating state, and changes a potential of the gate electrode in the floating state via the parasitic capacitance and causes a current to flow via the drive transistor to increase a voltage between the other source/drain region and the gate electrode, and then applies the reference voltage to the gate electrode of the drive transistor,

afterwards, performs write processing that applies a video signal voltage to the gate electrode of the drive transistor, and

subsequently, sets the gate electrode of the drive transistor in the floating state to cause the light-emitting unit to emit light.

[28]

The electronic device according to [27], in which

the threshold voltage cancellation processing is performed to apply a first drive voltage to the one source/drain region in the state where the reference voltage is applied to the gate electrode of the drive transistor, to bring the potential of the other source/drain region closer to the potential obtained by subtracting the threshold voltage of the drive transistor from the reference voltage, and

subsequently, the gate electrode of the drive transistor is set in the floating state and the voltage of the one source/drain region of the drive transistor is switched to a second drive voltage exceeding the first drive voltage, to change the potential of the gate electrode in the floating state via the parasitic capacitance and cause the current to flow via the drive transistor, to increase the voltage between the other source/drain region and the gate electrode, and then the reference voltage is applied to the gate electrode of the drive transistor.

[29]

The electronic device according to [28], in which

before the threshold voltage cancellation processing, the potential of the other source/drain region is initialized by switching the voltage applied to the one source/drain region of the drive transistor from the second drive voltage to an initialization voltage.

[30]

The electronic device according to [29], in which

the initialization voltage is a voltage set to a predetermined value lower than a voltage obtained by subtracting the threshold voltage of the drive transistor from the reference voltage.

[31]

The electronic device according to any of [28] to [30], in which

the display element further includes a write transistor connected to the gate electrode of the drive transistor, and

the video signal voltage is applied to the gate electrode of the drive transistor via the write transistor set in a conductive state.

[32]

The electronic device according to [31], in which

the reference voltage is applied to the gate electrode of the drive transistor via the write transistor set in the conductive state.

[33]

The electronic device according to [27], in which

a voltage is applied to the one source/drain region of the drive transistor via a light emission control transistor,

the threshold voltage cancellation processing is performed to apply the drive voltage to the one source/drain region of the drive transistor via the light emission control transistor set in a conductive state due to application of a first control voltage to its gate electrode, in a state where the reference voltage is applied to the gate electrode of the drive transistor, to bring the potential of the other source/drain region closer to the potential obtained by subtracting the threshold voltage of the drive transistor from the reference voltage, and

subsequently, the gate electrode of the drive transistor is set in the floating state and the voltage applied to the gate of the light emission control transistor is switched to a second control voltage exceeding the first control voltage, to change the potential of the gate electrode in the floating state via the parasitic capacitance and cause the current to flow via the drive transistor, to increase the voltage between the other source/drain region and the gate electrode, and then the reference voltage is applied to the gate electrode of the drive transistor.

[34]

The electronic device according to [33], in which

the display element further includes a write transistor connected to the gate electrode of the drive transistor, and

the video signal voltage is applied to the gate electrode of the drive transistor via the write transistor set in a conductive state.

[35]

The electronic device according to [34], in which

before the threshold voltage cancellation processing,

the light emission control transistor is set in the non-conductive state and a voltage exceeding the reference voltage is applied to the gate electrode of the drive transistor and subsequently the reference voltage is applied, to initialize the potential of the other source/drain region of the drive transistor.

[36]

The electronic device according to [34], in which

the voltage exceeding the reference voltage and the reference voltage are applied to the gate electrode of the drive transistor via the write transistor set in the conductive state.

[37]

The electronic device according to any of [27] to [36], in which

the potential of the other source/drain region of the drive transistor changes due to the current flowing through the drive transistor, in the write processing.

[38]

The electronic device according to any of [27] to [37], in which

the light-emitting unit includes a current drive type electro-optical element whose light emission luminance varies in accordance with a value of a current flowing.

[39]

The electronic device according to [38], in which

the light-emitting unit is an organic electroluminescence element.

### REFERENCE SIGNS LIST

1, 1A, 1B, 1C, 1D Display device
2 Display unit
3 Display element
21 Support
22 Transparent substrate
31 Gate electrode
32 Gate insulating layer
33 Semiconductor layer
34 Channel formation region
35A One source/drain region
35B Other source/drain region
36 One electrode
37 Other electrode
38, 39 Wiring line
40 Interlayer insulating layer
51 Anode electrode
52 Hole transporting layer, light emitting layer, and electron transporting layer
53 Cathode electrode
54 Second interlayer insulating layer
55, 56 Contact hole
100 Power supply unit
101 Scanning unit
102 Data driver
103 First node initialization circuit
104 Light emission control unit
105 Second node initialization circuit
SCL Scanning line
DTL Data line
PS1 Feeder line
PS2 Common feeder line
CL Light emission control line
AZ1 First node initialization control line
AZ2 Second node initialization control line
TR_{W} Write transistor
TR_{D} Drive transistor
TR₁ First node initialization transistor
TR₂ Second node initialization transistor
TR_{EL}_{_}_{C} Light emission control transistor
C_{S} Capacitor
ELP Organic electroluminescence light-emitting unit
C_{EL} Capacity of light-emitting unit ELP
ND₁ First node
ND₂ Second node
311 Camera body part
312 Photographing lens unit
313 Grip part
314 Monitor
315 Viewfinder
500 Eyeglasses
511 See-through head mounted display
512 Body part
513 Arm
514 Lens barrel

1. A method for driving a display element, the method comprising:
in driving a display element including an n-channel drive transistor in which a voltage is applied to one source/drain region and a light-emitting unit is connected to another source/drain region, and a capacitor connected between a gate electrode of the drive transistor and the other source/drain region,
performing threshold voltage cancellation processing that applies a drive voltage to the one source/drain region in a state where a reference voltage is applied to the gate electrode of the drive transistor, to bring a potential of the other source/drain region closer to a potential obtained by subtracting a threshold voltage of the drive transistor from the reference voltage;
subsequently, setting the gate electrode of the drive transistor in a floating state, and changing a potential of the gate electrode in the floating state via parasitic capacitance and causing a current to flow via the drive transistor to increase a voltage between the other source/drain region and the gate electrode, and then applying the reference voltage to the gate electrode of the drive transistor;
afterwards, performing write processing that applies a video signal voltage to the gate electrode of the drive transistor; and
subsequently, setting the gate electrode of the drive transistor in the floating state to cause the light-emitting unit to emit light.

2. The method for driving a display element according to claim 1, wherein
the threshold voltage cancellation processing is performed to apply a first drive voltage to the one source/drain region in the state where the reference voltage is applied to the gate electrode of the drive transistor, to bring the potential of the other source/drain region closer to the potential obtained by subtracting the threshold voltage of the drive transistor from the reference voltage, and
subsequently, the gate electrode of the drive transistor is set in the floating state and the voltage of the one source/drain region of the drive transistor is switched to a second drive voltage exceeding the first drive voltage, to change the potential of the gate electrode in the floating state via the parasitic capacitance and cause the current to flow via the drive transistor, to increase the voltage between the other source/drain region and the gate electrode, and then the reference voltage is applied to the gate electrode of the drive transistor.

3. The method for driving a display element according to claim 2, wherein
before the threshold voltage cancellation processing, the potential of the other source/drain region is initialized by switching the voltage applied to the one source/drain region of the drive transistor from the second drive voltage to an initialization voltage.

4. The method for driving a display element according to claim 3, wherein
the initialization voltage is a voltage set to a predetermined value lower than a voltage obtained by subtracting the threshold voltage of the drive transistor from the reference voltage.

5. The method for driving a display element according to claim 2, wherein
the display element further includes a write transistor connected to the gate electrode of the drive transistor, and
the video signal voltage is applied to the gate electrode of the drive transistor via the write transistor set in a conductive state.

6. The method for driving a display element according to claim 5, wherein
the reference voltage is applied to the gate electrode of the drive transistor via the write transistor set in the conductive state.

7. The method for driving a display element according to claim 1, wherein
a voltage is applied to the one source/drain region of the drive transistor via a light emission control transistor,
the threshold voltage cancellation processing is performed to apply the drive voltage to the one source/drain region of the drive transistor via the light emission control transistor set in a conductive state due to application of a first control voltage to its gate electrode, in a state where the reference voltage is applied to the gate electrode of the drive transistor, to bring the potential of the other source/drain region closer to the potential obtained by subtracting the threshold voltage of the drive transistor from the reference voltage, and
subsequently, the gate electrode of the drive transistor is set in the floating state and the voltage applied to the gate of the light emission control transistor is switched to a second control voltage exceeding the first control voltage, to change the potential of the gate electrode in the floating state via the parasitic capacitance and cause the current to flow via the drive transistor, to increase the voltage between the other source/drain region and the gate electrode, and then the reference voltage is applied to the gate electrode of the drive transistor.

8. The method for driving a display element according to claim 7, wherein
the display element further includes a write transistor connected to the gate electrode of the drive transistor, and
the video signal voltage is applied to the gate electrode of the drive transistor via the write transistor set in a conductive state.

9. The method for driving a display element according to claim 8, wherein
before the threshold voltage cancellation processing,
the light emission control transistor is set in the non-conductive state and a voltage exceeding the reference voltage is applied to the gate electrode of the drive transistor and subsequently the reference voltage is applied, to initialize the potential of the other source/drain region of the drive transistor.

10. The method for driving a display element according to claim 8, wherein
the voltage exceeding the reference voltage and the reference voltage are applied to the gate electrode of the drive transistor via the write transistor set in the conductive state.

11. The method for driving a display element according to claim 1, wherein
the potential of the other source/drain region of the drive transistor changes due to the current flowing through the drive transistor, in the write processing.

12. The method for driving a display element according to claim 1, wherein
the light-emitting unit includes a current drive type electro-optical element whose light emission luminance varies in accordance with a value of a current flowing.

13. The method for driving a display element according to claim 12, wherein
the light-emitting unit is an organic electroluminescence element.

14. A display device comprising:
a display unit in which a display element is disposed, the display element including an n-channel drive transistor in which a voltage is applied to one source/drain region and a light-emitting unit is connected to another source/drain region, and a capacitor connected between a gate electrode of the drive transistor and the other source/drain region; and a drive unit that drives the display unit, wherein
the drive unit
performs threshold voltage cancellation processing that applies a drive voltage to the one source/drain region in a state where a reference voltage is applied to the gate electrode of the drive transistor, to bring a potential of the other source/drain region closer to a potential obtained by subtracting a threshold voltage of the drive transistor from the reference voltage,
subsequently, sets the gate electrode of the drive transistor in a floating state, and changes a potential of the gate electrode in the floating state via the parasitic capacitance and causes a current to flow via the drive transistor to increase a voltage between the other source/drain region and the gate electrode, and then applies the reference voltage to the gate electrode of the drive transistor,
afterwards, performs write processing that applies a video signal voltage to the gate electrode of the drive transistor, and
subsequently, sets the gate electrode of the drive transistor in the floating state to cause the light-emitting unit to emit light.

15. An electronic device comprising a display device, wherein
the display device includes:
a display unit in which a display element is disposed, the display element including an n-channel drive transistor in which a voltage is applied to one source/drain region and a light-emitting unit is connected to another source/drain region, and a capacitor connected between a gate electrode of the drive transistor and the other source/drain region; and a drive unit that drives the display unit, wherein
the drive unit
performs threshold voltage cancellation processing that applies a drive voltage to the one source/drain region in a state where a reference voltage is applied to the gate electrode of the drive transistor, to bring a potential of the other source/drain region closer to a potential obtained by subtracting a threshold voltage of the drive transistor from the reference voltage,
subsequently, sets the gate electrode of the drive transistor in a floating state, and changes a potential of the gate electrode in the floating state via the parasitic capacitance and causes a current to flow via the drive transistor to increase a voltage between the other source/drain region and the gate electrode, and then applies the reference voltage to the gate electrode of the drive transistor,
afterwards, performs write processing that applies a video signal voltage to the gate electrode of the drive transistor, and
subsequently, sets the gate electrode of the drive transistor in the floating state to cause the light-emitting unit to emit light.
